(19) United States
(12) Patent Application Publication
(10) Pub. No.: US 2025/0248455 A1
(43) Pub. Date: Aug. 7, 2025

(54) AEROSOL-GENERATING DEVICE AND OPERATION METHOD THEREOF

(71) Applicant: KT&G CORPORATION, Daejeon (KR)

(72) Inventors: Hyungjin JUNG, Seoul (KR); Taehun KIM, Yongin-si Gyeonggi-do (KR); Jueon PARK, Seoul (KR); Jungho HAN, Daejeon (KR)

(73) Assignee: KT&G CORPORATION, Daejeon (KR)

(21) Appl. No.: 18/695,289

(22) PCT Filed: Oct. 25, 2022
(86) PCT No.: PCT/KR2022/016383

§ 371 Date: Mar. 25, 2024

(30) Foreign Application Priority Data
Oct. 26, 2021 (KR) 10-2021-0144045
Mar. 16, 2022 (KR) 10-2022-0032900

(51) Int. Cl. A24F 40/60; A24F 40/465; A24F 40/57; H05B 6/10

(52) U.S. Cl. CPC A24F 40/60; A24F 40/465; A24F 40/57; H05B 6/108

(57) ABSTRACT

An aerosol-generating device and an operation method thereof are disclosed. The aerosol-generating device of the disclosure includes a display, a button, and a controller. Upon receiving first input through the button while a screen indicating a first state among a plurality of states is displayed, the controller changes the screen indicating the first state to a screen indicating a second state. Upon receiving second input, which is different from the first input, through the button while the screen indicating the first state is displayed, the controller changes the screen indicating the first state to a setting screen related to the first state. Upon receiving input through the button while the setting screen related to the first state is displayed, the controller updates settings related to the first state. The controller changes the setting screen related to the first state to the screen indicating the first state in response to update.

### TECHNICAL FIELD

The present disclosure relates to an aerosol-generating device and an operation method thereof.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE

### Technical Problem

It is an object of the present disclosure to solve the above and other problems.

It is another object of the present disclosure to provide an aerosol-generating device and an operation method thereof capable of providing various pieces of information about the state of the aerosol-generating device to a user through a display.

It is still another object of the present disclosure to provide an aerosol-generating device and an operation method thereof capable of intuitively displaying information about a currently performed operation.

It is still another object of the present disclosure to provide an aerosol-generating device and an operation method thereof capable of updating settings related to the aerosol-generating device in various manners using one button.

### Technical Solution

An aerosol-generating device according to an aspect of the present disclosure for accomplishing the above and other objects may include a heater configured to heat an aerosol-generating substance, a display, a button, and a controller. Upon receiving first input through the button while a screen indicating a first state among a plurality of states is displayed, the controller may change the screen indicating the first state to a screen indicating a second state among the plurality of states. Upon receiving second input, which is different from the first input, through the button while the screen indicating the first state is displayed, the controller may change the screen indicating the first state to a setting screen related to the first state. Upon receiving input through the button while the setting screen related to the first state is displayed, the controller may update settings related to the first state. The controller may change the setting screen related to the first state to the screen indicating the first state in response to update of the settings related to the first state.

An operation method of an aerosol-generating device according to an aspect of the present disclosure for accomplishing the above and other objects may include changing, upon receiving first input through a button while a screen indicating a first state among a plurality of states is displayed on a display included in the aerosol-generating device, the screen indicating the first state to a screen indicating a second state among the plurality of states, changing, upon receiving second input, which is different from the first input, through the button while the screen indicating the first state is displayed, the screen indicating the first state to a setting screen related to the first state, updating, upon receiving input through the button while the setting screen related to the first state is displayed, settings related to the first state, and changing the setting screen related to the first state to the screen indicating the first state in response to update of the settings related to the first state.

### Advantageous Effects

According to at least one of embodiments of the present disclosure, it may be possible to provide various pieces of information about the state of an aerosol-generating device to a user through a display.

According to at least one of embodiments of the present disclosure, it may be possible to intuitively display information about an operation that is currently performed by an aerosol-generating device.

According to at least one of embodiments of the present disclosure, it may be possible to update settings related to an aerosol-generating device in various manners using one button.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### DESCRIPTION OF DRAWINGS

The above and other objects, features and other advantages of the present disclosure will be more clearly understood from the following detailed description taken in conjunction with the accompanying drawings, in which:

FIG. 1 is a block diagram of an aerosol-generating device according to an embodiment of the present disclosure;

FIGS. 2 and 3 are views for explaining an aerosol-generating device according to embodiments of the present disclosure;

FIGS. 4 and 5 are views for explaining a stick according to embodiments of the present disclosure;

FIG. 6 is a diagram for explaining the configuration of an aerosol-generating device according to an embodiment of the present disclosure; and

FIGS. 7 to 48 are diagrams for explaining the operation of an aerosol-generating device according to an embodiment of the present disclosure.

### BEST MODE

Hereinafter, the embodiments disclosed in the present specification will be described in detail with reference to the accompanying drawings. The same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description. The “module” and “unit” are do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that the terms “first”, “second”, etc., may be used herein to describe various components. However, these components should not be limited by these terms. These terms are only used to distinguish one component from another component.

It will be understood that when a component is referred to as being “connected to” or “coupled to” another component, it may be directly connected to or coupled to another component. However, it will be understood that intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

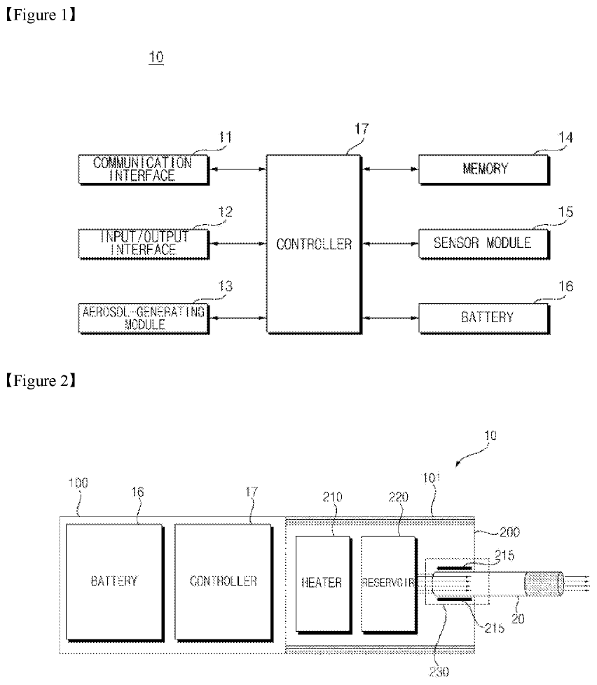

FIG. 1 is a block diagram of an aerosol-generating device according to an embodiment of the present disclosure.

Referring to FIG. 1, an aerosol-generating device 10 may include a communication interface 11, an input/output interface 12, an aerosol-generating module 13, a memory 14, a sensor module 15, a battery 16, and/or a controller 17.

In one embodiment, the aerosol-generating device 10 may be composed only of a main body. In this case, components included in the aerosol-generating device 10 may be located in the main body. In another embodiment, the aerosol-generating device 10 may be composed of a cartridge, which contains an aerosol-generating substance, and a main body. In this case, the components included in the aerosol-generating device 10 may be located in at least one of the main body or the cartridge.

The communication interface 11 may include at least one communication module for communication with an external device and/or a network. For example, the communication interface 11 may include a communication module for wired communication, such as a Universal Serial Bus (USB). For example, the communication interface 11 may include a communication module for wireless communication, such as Wireless Fidelity (Wi-Fi), Bluetooth, Bluetooth Low Energy (BLE), ZigBee, or nearfield communication (NFC).

The input/output interface 12 may include an input device (not shown) for receiving a command from a user and/or an output device (not shown) for outputting information to the user. For example, the input device may include a touch panel, a physical button, a microphone, or the like. For example, the output device may include a display device for outputting visual information, such as a display or a light-emitting diode (LED), an audio device for outputting auditory information, such as a speaker or a buzzer, a motor for outputting tactile information such as haptic effect, or the like.

The input/output interface 12 may transmit data corresponding to a command input by the user through the input device to another component (or other components) of the aerosol-generating device 100. The input/output interface 12 may output information corresponding to data received from another component (or other components) of the aerosol-generating device 10 through the output device.

The aerosol-generating module 13 may generate an aerosol from an aerosol-generating substance. Here, the aerosol-generating substance may be a substance in a liquid state, a solid state, or a gel state, which is capable of generating an aerosol, or a combination of two or more aerosol-generating substances.

According to an embodiment, the liquid aerosol-generating substance may be a liquid including a tobacco-containing material having a volatile tobacco flavor component. According to another embodiment, the liquid aerosol-generating substance may be a liquid including a non-tobacco material. For example, the liquid aerosol-generating substance may include water, solvents, nicotine, plant extracts, flavorings, flavoring agents, vitamin mixtures, etc.

The solid aerosol-generating substance may include a solid material based on a tobacco raw material such as a reconstituted tobacco sheet, shredded tobacco, or granulated tobacco. In addition, the solid aerosol-generating substance may include a solid material having a taste control agent and a flavoring material. For example, the taste control agent may include calcium carbonate, sodium bicarbonate, calcium oxide, etc. For example, the flavoring material may include a natural material such as herbal granules, or may include a material such as silica, zeolite, or dextrin, which includes an aroma ingredient.

In addition, the aerosol-generating substance may further include an aerosol-forming agent such as glycerin or propylene glycol.

The aerosol-generating module 13 may include at least one heater (not shown).

The aerosol-generating module 13 may include an electro-resistive heater. For example, the electro-resistive heater may include at least one electrically conductive track. The electro-resistive heater may be heated as current flows through the electrically conductive track. At this time, the aerosol-generating substance may be heated by the heated electro-resistive heater.

The electrically conductive track may include an electro-resistive material. In one example, the electrically conductive track may be formed of a metal material. In another example, the electrically conductive track may be formed of a ceramic material, carbon, a metal alloy, or a composite of a ceramic material and metal.

The electro-resistive heater may include an electrically conductive track that is formed in any of various shapes. For example, the electrically conductive track may be formed in any one of a tubular shape, a plate shape, a needle shape, a rod shape, and a coil shape.

The aerosol-generating module 13 may include a heater that uses an induction-heating method. For example, the induction heater may include an electrically conductive coil. The induction heater may generate an alternating magnetic field, which periodically changes in direction, by adjusting the current flowing through the electrically conductive coil. At this time, when the alternating magnetic field is applied to a magnetic body, energy loss may occur in the magnetic body due to eddy current loss and hysteresis loss. In addition, the lost energy may be released as thermal energy. Accordingly, the aerosol-generating substance located adjacent to the magnetic body may be heated. Here, an object that generates heat due to the magnetic field may be referred to as a susceptor.

Meanwhile, the aerosol-generating module 13 may generate ultrasonic vibrations to thereby generate an aerosol from the aerosol-generating substance.

The aerosol-generating device 10 may be referred to as a cartomizer, an atomizer, or a vaporizer.

The memory 14 may store programs for processing and controlling each signal in the controller 17. The memory 14 may store processed data and data to be processed.

For example, the memory 14 may store applications designed for the purpose of performing various tasks that can be processed by the controller 17. The memory 14 may selectively provide some of the stored applications in response to the request from the controller 17.

For example, the memory 14 may store data on the operation time of the aerosol-generating device 100, the maximum number of puffs, the current number of puffs, the number of uses of battery 16, at least one temperature profile, the user's inhalation pattern, and data about charging/discharging. Here, “puff” means inhalation by the user. “inhalation” means the user's act of taking air or other substances into the user's oral cavity, nasal cavity, or lungs through the user's mouth or nose.

The memory 14 may include at least one of volatile memory (e.g. dynamic random access memory (DRAM), static random access memory (SRAM), or synchronous dynamic random access memory (SDRAM)), nonvolatile memory (e.g. flash memory), a hard disk drive (HDD), or a solid-state drive (SSD).

The sensor module 15 may include at least one sensor.

For example, the sensor module 15 may include a sensor for sensing a puff (hereinafter referred to as a “puff sensor”). In this case, the puff sensor may be implemented as a proximity sensor such as an IR sensor, a pressure sensor, a gyro sensor, an acceleration sensor, a magnetic field sensor, or the like.

For example, the sensor module 15 may include a sensor for sensing a puff (hereinafter referred to as a “puff sensor”). In this case, the puff sensor may be implemented by a pressure sensor, a gyro sensor, an acceleration sensor, a magnetic field sensor, or the like.

For example, the sensor module 15 may include a sensor for sensing the temperature of the heater included in the aerosol-generating module 13 and the temperature of the aerosol-generating substance (hereinafter referred to as a “temperature sensor”). In this case, the heater included in the aerosol-generating module 13 may also serve as the temperature sensor. For example, the electro-resistive material of the heater may be a material having a predetermined temperature coefficient of resistance. The sensor module 15 may measure the resistance of the heater, which varies according to the temperature, to thereby sense the temperature of the heater.

For example, in the case in which the main body of the aerosol-generating device 10 is formed to allow a stick to be inserted thereinto, the sensor module 15 may include a sensor for sensing insertion of the stick (hereinafter referred to as a “stick detection sensor”).

For example, in the case in which the aerosol-generating device 10 includes a cartridge, the sensor module 15 may include a sensor for sensing mounting/demounting of the cartridge and the position of the cartridge (hereinafter referred to as a “cartridge detection sensor”).

In this case, the stick detection sensor and/or the cartridge detection sensor may be implemented as an inductance-based sensor, a capacitive sensor, a resistance sensor, or a Hall sensor (or Hall IC) using a Hall effect.

For example, the sensor module 15 may include a voltage sensor for sensing a voltage applied to a component (e.g. the battery 16) provided in the aerosol-generating device 10 and/or a current sensor for sensing a current.

For example, the sensor module 15 may include a sensor (hereinafter, referred to as a “residual amount detection sensor”) for detecting the remaining amount of the aerosol generating material stored in the cartridge. In this case, the residual amount detection sensor may be implemented as a capacitive sensor for detecting a change in capacitance depending on the remaining amount of aerosol-generating material, an optical sensor for detecting the surface of a liquid aerosol-generating material, a proximity sensor for detecting an object whose position changes depending on the remaining amount of aerosol-generating material, or the like.

The battery 16 may supply electric power used for the operation of the aerosol-generating device 10 under the control of the controller 17. The battery 16 may supply electric power to other components provided in the aerosol-generating device 100. For example, the battery 16 may supply electric power to the communication module included in the communication interface 11, the output device included in the input/output interface 12, and the heater included in the aerosol-generating module 13.

The battery 16 may be a rechargeable battery or a disposable battery. For example, the battery 16 may be a lithium-ion (Li-ion) battery or a lithium polymer (Li-polymer) battery. However, the present disclosure is not limited thereto. For example, when the battery 16 is rechargeable, the charging rate (C-rate) of the battery 16 may be 10C, and the discharging rate (C-rate) thereof may be 10C to 20C. However, the present disclosure is not limited thereto. Also, for stable use, the battery 16 may be manufactured such that 80% or more of the total capacity may be ensured even when charging/discharging is performed 2000 times.

The aerosol-generating device 10 may further include a protection circuit module (PCM) (not shown), which is a circuit for protecting the battery 16. The protection circuit module (PCM) may be disposed adjacent to the upper surface of the battery 16. For example, in order to prevent overcharging and overdischarging of the battery 16, the protection circuit module (PCM) may cut off the electrical path to the battery 16 when a short circuit occurs in a circuit connected to the battery 16, when an overvoltage is applied to the battery 16, or when an overcurrent flows through the battery 16.

The aerosol-generating device 10 may further include a charging terminal to which electric power supplied from the outside is input. For example, the charging terminal may be formed at one side of the main body of the aerosol-generating device 100. The aerosol-generating device 10 may charge the battery 16 using electric power supplied through the charging terminal. In this case, the charging terminal may be configured as a wired terminal for USB communication, a pogo pin, or the like.

The aerosol-generating device 10 may further include a power terminal (not shown) to which electric power supplied from the outside is input. For example, a power line may be connected to the power terminal, which is disposed at one side of the main body of the aerosol-generating device 100. The aerosol-generating device 10 may use the electric power supplied through the power line connected to the power terminal to charge the battery 16. In this case, the power terminal may be a wired terminal for USB communication.

The aerosol-generating device 10 may wirelessly receive electric power supplied from the outside through the communication interface 11. For example, the aerosol-generating device 10 may wirelessly receive electric power using an antenna included in the communication module for wireless communication. The aerosol-generating device 10 may charge the battery 16 using the wirelessly supplied electric power.

The controller 17 may control the overall operation of the aerosol-generating device 100. The controller 17 may be connected to each of the components provided in the aerosol-generating device 100. The controller 17 may transmit and/or receive a signal to and/or from each of the components, thereby controlling the overall operation of each of the components.

The controller 17 may include at least one processor. The controller 17 may control the overall operation of the aerosol-generating device 10 using the processor included therein. Here, the processor may be a general processor such as a central processing unit (CPU). Of course, the processor may be a dedicated device such as an application-specific integrated circuit (ASIC), or may be any of other hardware-based processors.

The controller 17 may perform any one of a plurality of functions of the aerosol-generating device 100. For example, the controller 17 may perform any one of a plurality of functions of the aerosol-generating device 10 (e.g. a preheating function, a heating function, a charging function, and a cleaning function) according to the state of each of the components provided in the aerosol-generating device 10 and the user's command received through the input/output interface 12.

The controller 17 may control the operation of each of the components provided in the aerosol-generating device 10 based on data stored in the memory 14. For example, the controller 17 may control the supply of a predetermined amount of electric power from the battery 16 to the aerosol-generating module 13 for a predetermined time based on the data on the temperature profile, the user's inhalation pattern, which is stored in the memory 14.

The controller 17 may determine the occurrence or non-occurrence of a puff using the puff sensor included in the sensor module 15. For example, the controller 17 may check a temperature change, a flow change, a pressure change, and a voltage change in the aerosol-generating device 10 based on the values sensed by the puff sensor. The controller 17 may determine the occurrence or non-occurrence of a puff based on the value sensed by the puff sensor.

The controller 17 may control the operation of each of the components provided in the aerosol-generating device 10 according to the occurrence or non-occurrence of a puff and/or the number of puffs. For example, the controller 17 may perform control such that the temperature of the heater is changed or maintained based on the temperature profile stored in the memory 14.

The controller 17 may perform control such that the supply of electric power to the heater is interrupted according to a predetermined condition. For example, the controller 17 may perform control such that the supply of electric power to the heater is interrupted when the stick is removed, when the cartridge is demounted, when the number of puffs reaches the predetermined maximum number of puffs, when a puff is not sensed during a predetermined period of time or longer, or when the remaining capacity of the battery 16 is less than a predetermined value.

The controller 17 may calculate the remaining capacity with respect to the full charge capacity of the battery 16. For example, the controller 17 may calculate the remaining capacity of the battery 16 based on the values sensed by the voltage sensor and/or the current sensor included in the sensor module 15.

The controller 17 may perform control such that electric power is supplied to the heater using at least one of a pulse width modulation (PWM) method or a proportional-integral-differential (PID) method.

For example, the controller 17 may perform control such that a current pulse having a predetermined frequency and a predetermined duty ratio is supplied to the heater using the PWM method. In this case, the controller 17 may control the amount of electric power supplied to the heater by adjusting the frequency and the duty ratio of the current pulse.

For example, the controller 17 may determine a target temperature to be controlled based on the temperature profile. In this case, the controller 17 may control the amount of electric power supplied to the heater using the PID method, which is a feedback control method using a difference value between the temperature of the heater and the target temperature, a value obtained by integrating the difference value with respect to time, and a value obtained by differentiating the difference value with respect to time.

Although the PWM method and the PID method are described as examples of methods of controlling the supply of electric power to the heater, the present disclosure is not limited thereto, and may employ any of various control methods, such as a proportional-integral (PI) method or a proportional-differential (PD) method.

Meanwhile, the controller 17 may perform control such that electric power is supplied to the heater according to a predetermined condition. For example, when a cleaning function for cleaning the space into which the stick is inserted is selected in response to a command input by the user through the input/output interface 12, the controller 17 may perform control such that a predetermined amount of electric power is supplied to the heater.

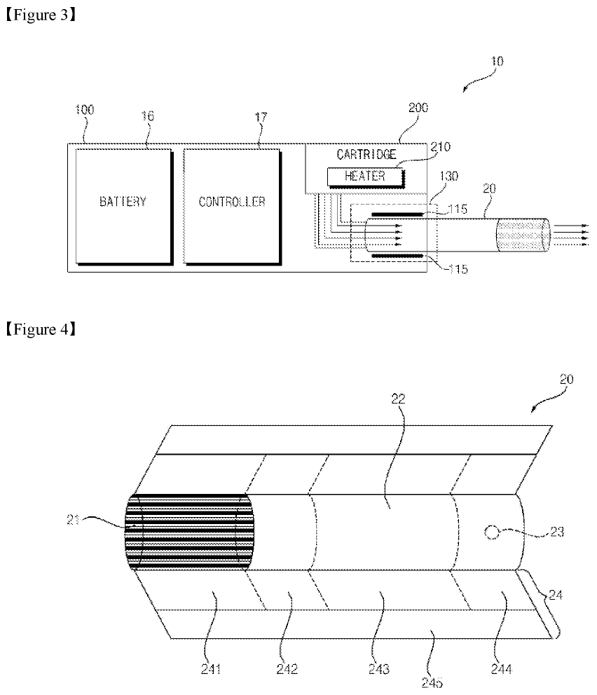

FIGS. 2 and 3 are views for explaining an aerosol-generating device according to embodiments of the present disclosure.

According to various embodiments of the present disclosure, the aerosol-generating device 10 may include a main body 100 and/or a cartridge 200.

Referring to FIG. 2, the aerosol-generating device 10 according to an embodiment may include a main body 100 and a cartridge 200. The main body 100 may support the cartridge 200, and the cartridge 200 may contain an aerosol-generating substance.

According to one embodiment, the cartridge 200 may be configured so as to be detachably mounted to the main body 100. According to another embodiment, the cartridge 200 may be integrally configured with the main body 100. For example, the cartridge 200 may be mounted to the main body 100 in a manner such that at least a portion of the cartridge 200 is inserted into the insertion space formed by a housing 101 of the main body 100.

The main body 100 may be formed to have a structure in which external air can be introduced into the main body 100 in the state in which the cartridge 200 is inserted thereinto. Here, the external air introduced into the main body 100 may flow into the user's mouth via the cartridge 200.

The controller 17 may determine whether the cartridge 200 is in a mounted state or a detached state using a cartridge detection sensor included in the sensor module 15. For example, the cartridge detection sensor may transmit a pulse current through a first terminal connected with the cartridge 200. In this case, the controller 17 may determine whether the cartridge 200 is in a connected state, based on whether the pulse current is received through a second terminal.

The cartridge 200 may include an insertion space 230 configured to allow the stick 20 to be inserted. For example, the cartridge 200 may include the insertion space formed by an inner wall extending in a circumferential direction along a direction in which the stick 20 is inserted. In this case, the insertion space may be formed by opening the inner side of the inner wall up and down. The stick 20 may be inserted into the insertion space formed by the inner wall.

The insertion space into which the stick 20 is inserted may be formed in a shape corresponding to the shape of a portion of the stick 20 inserted into the insertion space. For example, when the stick 20 is formed in a cylindrical shape, the insertion space may be formed in a cylindrical shape.

When the stick 20 is inserted into the insertion space, the outer surface of the stick 20 may be surrounded by the inner wall and contact the inner wall. A portion of the stick 20 may be inserted into the insertion space 230 in the cartridge 200, and the remaining portion thereof may be exposed to the outside.

The stick 20 may be similar to a general combustive cigarette. For example, the stick 20 may be divided into a first portion including an aerosol generating material and a second portion including a filter and the like. Alternatively, an aerosol generating material may be included in the second portion of the stick 20. For example, a flavoring substance made in the form of granules or capsules may be inserted into the second portion.

The entire first portion is inserted into the insertion space of the aerosol-generating device 10, and the second portion may be exposed to the outside. Alternatively, only a portion of the first portion may be inserted into the insertion space of the aerosol-generating device 10, or a portion of the first portion and the second portion may be inserted. The user may inhale the aerosol while biting the second portion with the mouth.

The cartridge 200 may include a first heater 210 for heating an aerosol-generating substance, a second heater 215 for heating the stick 20, and/or a storage unit 220 containing the aerosol-generating substance. For example, a liquid delivery element impregnated with (containing) the aerosol-generating substance may be disposed in the storage unit 220. The storage unit 220 storing liquid may be referred to as a chamber 220.

The electrically conductive track of the first heater 210 may be formed in a structure that is wound around the liquid delivery element. In this case, when the liquid delivery element is heated by the first heater 210, an aerosol may be generated. Here, the liquid delivery element may include a wick made of, for example, cotton fiber, ceramic fiber, glass fiber, or porous ceramic.

The second heater 215 may be disposed in the cartridge 200 at a position corresponding to a position at which the stick 20 is located after being inserted into the insertion space 230. The second heater 215 may be implemented as an electrically conductive heater and/or an induction heating type heater.

The second heater 215 may heat the inside and/or the outside of the stick 20 using the power supplied from the battery 16. In this case, an aerosol may be generated in the heated stick 20.

The user may inhale the aerosol while biting one end of the stick 20 with the mouth. The aerosol generated by the heater 210 may pass through the stick 20 and be delivered to the user's mouth. At this time, while the aerosol passes through the stick 20, the material contained in the stick 20 may be added to the aerosol.

Referring to FIG. 3, the aerosol-generating device 10 according to an embodiment may include a main body 100 supporting the cartridge 200 and a cartridge 200 containing an aerosol-generating substance. The main body 100 may be formed so as to allow the stick 20 to be inserted into an insertion space 130 therein. The stick 20 may be inserted into the insertion space 130 defined by the inner wall of the housing 101 of the main body 100.

The aerosol-generating device 10 may include a first heater 210 for heating the aerosol-generating substance stored in the cartridge 200. For example, when the user holds one end of the stick 20 in the mouth to inhale the aerosol, the aerosol generated by the first heater 210 may pass through the stick 20. At this time, while the aerosol passes through the stick 20, a flavor may be added to the aerosol. The aerosol containing the flavor may be drawn into the user's oral cavity through one end of the stick 20.

The aerosol-generating device 10 may include a first heater 210 for heating the aerosol-generating substance stored in the cartridge 200 and a second heater 115 for heating the stick 20 inserted into the main body 100. For example, the aerosol-generating device 10 may generate an aerosol by heating the aerosol-generating substance stored in the cartridge 200 and the stick 20 using the first heater 210 and the second heater 115, respectively.

Hereinafter, the present disclosure will be described on the basis of an embodiment in which the stick 20 is inserted into the insertion space 130 defined in the housing 101 of the main body 100.

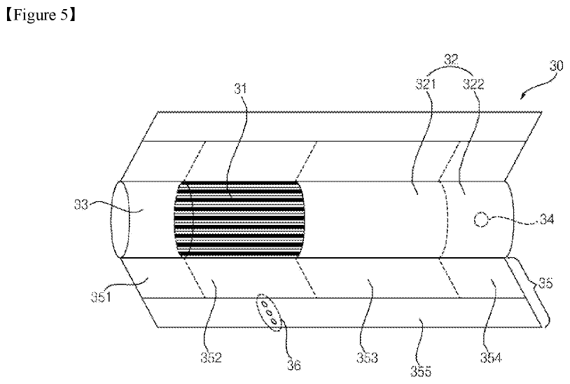

FIGS. 4 and 5 are views for explaining a stick according to embodiments of the present disclosure.

Referring to FIG. 4, the stick 20 may include a tobacco rod 21 and a filter rod 22. The first portion described above with reference to FIG. 2 may include the tobacco rod. The second portion described above with reference to FIG. 2 may include the filter rod 22.

FIG. 5 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, as necessary, the filter rod 22 may further include at least one segment configured to perform other functions.

A diameter of the stick 20 may be within a range of 5 mm to 9 mm, and a length of the stick 20 may be about 48 mm, but embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm, but embodiments are not limited thereto.

The stick 20 may be wrapped using at least one wrapper 24. The wrapper 24 may have at least one hole through which external air may be introduced or internal air may be discharged. For example, the stick 20 may be wrapped using one wrapper 24. As another example, the stick 20 may be double-wrapped using at least two wrappers 24. For example, the tobacco rod 21 may be wrapped using a first wrapper 241. For example, the filter rod 22 may be wrapped using wrappers 242, 243, 244. The tobacco rod 21 and the filter rod 22 wrapped by wrappers may be combined. The stick 20 may be re-wrapped by a single wrapper 245. When each of the tobacco rod 21 and the filter rod 22 includes a plurality of segments, each segment may be wrapped using wrappers 242, 243, 244. The entirety of stick 20 composed of a plurality of segments wrapped by wrappers may be re-wrapped by another wrapper

The first wrapper 241 and the second wrapper 242 may be formed of general filter wrapping paper. For example, the first wrapper 241 and the second wrapper 242 may be porous wrapping paper or non-porous wrapping paper. Also, the first wrapper 241 and the second wrapper 242 may be made of an oil-resistant paper sheet and an aluminum laminate packaging material.

The third wrapper 243 may be made of a hard wrapping paper. For example, a basis weight of the third wrapper 243 may be within a range of 88 g/m2 to 96 g/m2. For example, the basis weight of the third wrapper 243 may be within a range of 90 g/m2 to 94 g/m2. Also, a total thickness of the third wrapper 243 may be within a range of 1200 μm to 1300 μm. For example, the total thickness of the third wrapper 243 may be 125 μm.

The fourth wrapper 244 may be made of an oil-resistant hard wrapping paper. For example, a basis weight of the fourth wrapper 244 may be within a range of about 88 g/m2 to about 96 g/m2. For example, the basis weight of the fourth wrapper 244 may be within a range of 90 g/m2 to 94 g/m2. Also, a total thickness of the fourth wrapper 244 may be within a range of 1200 μm to 1300 μm. For example, the total thickness of the fourth wrapper 244 may be 125 μm.

The fifth wrapper 245 may be made of a sterilized paper (MFW). Here, the MFW refers to a paper specially manufactured to have enhanced tensile strength, water resistance, smoothness, and the like, compared to ordinary paper. For example, a basis weight of the fifth wrapper 245 may be within a range of 57 g/m2 to 63 g/m2. For example, a basis weight of the fifth wrapper 245 may be about 60 g/m2. Also, the total thickness of the fifth wrapper 245 may be within a range of 64 μm to 70 μm. For example, the total thickness of the fifth wrapper 245 may be 67 μm.

A predetermined material may be included in the fifth wrapper 245. Here, an example of the predetermined material may be, but is not limited to, silicon. For example, silicon exhibits characteristics like heat resistance with little change due to the temperature, oxidation resistance, resistances to various chemicals, water repellency, electrical insulation, etc. However, any material other than silicon may be applied to (or coated on) the fifth wrapper 245 without limitation as long as the material has the above-mentioned characteristics.

The fifth wrapper 245 may prevent the stick 20 from being burned. For example, when the tobacco rod 21 is heated by the heater 110, there is a possibility that the stick 20 is burned. In detail, when the temperature is raised to a temperature above the ignition point of any one of materials included in the tobacco rod 21, the stick 20 may be burned. Even in this case, since the fifth wrapper 245 include a non-combustible material, the burning of the stick 20 may be prevented.

Furthermore, the fifth wrapper 245 may prevent the aerosol generating device 100 from being contaminated by substances formed by the stick 20. Through puffs of a user, liquid substances may be formed in the stick 20. For example, as the aerosol formed by the stick 20 is cooled by the outside air, liquid materials (e.g., moisture, etc.) may be formed. As the fifth wrapper 245 wraps the stick 20, the liquid materials formed in the stick 20 may be prevented from being leaked out of the stick 20.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

The first segment of the filter rod 22 may be a cellulous acetate filter. For example, the first segment may be a tube-type structure having a hollow inside. The first segment may prevent an internal material of the tobacco rod 21 from being pushed back when the heater 110 is inserted into the tobacco rod 21 and may also provide a cooling effect to aerosol. A diameter of the hollow included in the first segment may be an appropriate diameter within a range of 2 mm to 4.5 mm but is not limited thereto.

The length of the first segment may be an appropriate length within a range of 4 mm to 30 mm but is not limited thereto. For example, the length of the first segment may be 10 mm but is not limited thereto.

The second segment of the filter rod 22 cools the aerosol which is generated when the heater 110 heats the tobacco rod 21. Therefore, the user may puff the aerosol which is cooled at an appropriate temperature.

The length or diameter of the second segment may be variously determined according to the shape of the stick 20. For example, the length of the second segment may be an appropriate length within a range of 7 mm to 20 mm. Preferably, the length of the second segment may be about 14 mm but is not limited thereto.

The second segment may be manufactured by weaving a polymer fiber. In this case, a flavoring liquid may also be applied to the fiber formed of the polymer. Alternatively, the second segment may be manufactured by weaving together an additional fiber coated with a flavoring liquid and a fiber formed of a polymer. Alternatively, the second segment may be formed by a crimped polymer sheet.

For example, a polymer may be formed of a material selected from the group consisting of polyethylene (PE), polypropylene (PP), polyvinyl chloride (PVC), polyethylene terephthalate (PET), polylactic acid (PLA), cellulous acetate (CA), and aluminum coil.

As the second segment is formed by the woven polymer fiber or the crimped polymer sheet, the second segment may include a single channel or a plurality of channels extending in a longitudinal direction. Here, a channel refers to a passage through which a gas (e.g., air or aerosol) passes.

For example, the second segment formed of the crimped polymer sheet may be formed from a material having a thickness between about 5 μm and about 300 μm, for example, between about 10 μm and about 250 μm. Also, a total surface area of the second segment may be between about 300 mm2/mm and about 1000 mm2/mm. In addition, an aerosol cooling element may be formed from a material having a specific surface area between about 10 mm2/mg and about 100 mm2/mg.

The second segment may include a thread including a volatile flavor component. Here, the volatile flavor component may be menthol but is not limited thereto. For example, the thread may be filled with a sufficient amount of menthol to provide the second segment with menthol of 1.5 mg or more.

The third segment of the filter rod 22 may be a cellulous acetate filter. The length of the third segment may be an appropriate length within a range of 4 mm to 20 mm. For example, the length of the third segment may be about 12 mm but is not limited thereto.

The filter rod 22 may be manufactured to generate flavors. For example, a flavoring liquid may be injected onto the filter rod 22. For example, an additional fiber coated with a flavoring liquid may be inserted into the filter rod 22.

Also, the filter rod 22 may include at least one capsule 23. Here, the capsule 23 may generate a flavor. The capsule 23 may generate an aerosol. For example, the capsule 23 may have a configuration in which a liquid including a flavoring material is wrapped with a film. The capsule 23 may have a spherical or cylindrical shape but is not limited thereto.

Referring to FIG. 5, a stick 30 may further include a front-end plug 33. The front-end plug 33 may be located on a side of a tobacco rod 31, the side not facing a filter rod 32. The front-end plug 33 may prevent the tobacco rod 31 from being detached and prevent liquefied aerosol from flowing into the aerosol generating device 10 from the tobacco rod 31, during smoking.

The filter rod 32 may include a first segment 321 and a second segment 322. The first segment 321 may correspond to the first segment of the filter rod 22 of FIG. 4. The segment 322 may correspond to the third segment of the filter rod 22 of FIG. 4.

A diameter and a total length of the stick 30 may correspond to the diameter and a total length of the stick 20 of FIG. 4. For example, a length of the front-end plug 33 may be about 7 mm, a length of the tobacco rod 31 may be about 15 mm, a length of the first segment 321 may be about 12 mm, and a length of the second segment 322 may be about 14 mm, but embodiments are not limited thereto.

The stick 30 may be wrapped using at least one wrapper 35. The wrapper 35 may have at least one hole through which external air may be introduced or internal air may be discharged. For example, the front-end plug 33 may be wrapped using a first wrapper 351, the tobacco rod 31 may be wrapped using a second wrapper 352, the first segment 321 may be wrapped using a third wrapper 353, and the second segment 322 may be wrapped using a fourth wrapper 354. Also, the entire stick 30 may be re-wrapped using a fifth wrapper 355.

In addition, the fifth wrapper 355 may have at least one perforation 36 formed therein. For example, the perforation 36 may be formed in an area of the fifth wrapper 355 surrounding the tobacco rod 31 but is not limited thereto. For example, the perforation 36 may transfer heat formed by the heater 210 illustrated in FIG. 3 into the tobacco rod 31.

Also, the second segment 322 may include at least one capsule 34. Here, the capsule 34 may generate a flavor. The capsule 34 may generate an aerosol. For example, the capsule 34 may have a configuration in which a liquid including a flavoring material is wrapped with a film. The capsule 34 may have a spherical or cylindrical shape but is not limited thereto.

The first wrapper 351 may be formed by combining general filter wrapping paper with a metal foil such as an aluminum coil. For example, a total thickness of the first wrapper 351 may be within a range of 45 μm to 55 μm. For example, the total thickness of the first wrapper 351 may be 50.3 μm. Also, a thickness of the metal coil of the first wrapper 351 may be within a range 6 μm to 7 μm. For example, the thickness of the metal coil of the first wrapper 351 may be 6.3 μm. In addition, a basis weight of the first wrapper 351 may be within a range of 50 g/m2 to 55 g/m2. For example, the basis weight of the first wrapper 351 may be 53 g/m2.

The second wrapper 352 and the third wrapper 353 may be formed of general filter wrapping paper. For example, the second wrapper 352 and the third wrapper 353 may be porous wrapping paper or non-porous wrapping paper.

For example, porosity of the second wrapper 352 may be 35000 CU but is not limited thereto. Also, a thickness of the second wrapper 352 may be within a range of 70 μm to 80 μm. For example, the thickness of the second wrapper 352 may be 78 μm. A basis weight of the second wrapper 352 may be within a range of 20 g/m2 to 25 g/m2. For example, the basis weight of the second wrapper 352 may be 23.5 g/m2.

For example, porosity of the third wrapper 353 may be 24000 CU but is not limited thereto. Also, a thickness of the third wrapper 353 may be in a range of about 60 μm to about 70 μm. For example, the thickness of the third wrapper 353 may be 68 μm. A basis weight of the third wrapper 353 may be in a range of about 20 g/m2 to about 25 g/m2. For example, the basis weight of the third wrapper 353 may be 21 g/m2.

The fourth wrapper 354 may be formed of PLA laminated paper. Here, the PLA laminated paper refers to three-layer paper including a paper layer, a PLA layer, and a paper layer. For example, a thickness of the fourth wrapper 353 may be in a range of 100 μm to 1200 μm. For example, the thickness of the fourth wrapper 353 may be 110 μm. Also, a basis weight of the fourth wrapper 354 may be in a range of 80 g/m2 to 100 g/m2. For example, the basis weight of the fourth wrapper 354 may be 88 g/m2.

The fifth wrapper 355 may be formed of sterilized paper (MFW). Here, the sterilized paper (MFW) refers to paper which is particularly manufactured to improve tensile strength, water resistance, smoothness, and the like more than ordinary paper. For example, a basis weight of the fifth wrapper 355 may be in a range of 57 g/m2 to 63 g/m2. For example, the basis weight of the fifth wrapper 355 may be 60 g/m2. Also, a thickness of the fifth wrapper 355 may be in a range of 64 μm to 70 μm. For example, the thickness of the fifth wrapper 355 may be 67 μm.

The fifth wrapper 355 may include a preset material added thereto. An example of the material may include silicon, but it is not limited thereto. Silicon has characteristics such as heat resistance robust to temperature conditions, oxidation resistance, resistance to various chemicals, water repellency to water, and electrical insulation, etc. Besides silicon, any other materials having characteristics as described above may be applied to (or coated on) the fifth wrapper 355 without limitation.

The front-end plug 33 may be formed of cellulous acetate. For example, the front-end plug 33 may be formed by adding a plasticizer (e.g., triacetin) to cellulous acetate tow. Mono-denier of filaments constituting the cellulous acetate tow may be in a range of 1.0 to 10.0. For example, the mono-denier of filaments constituting the cellulous acetate tow may be within a range of 4.0 to 6.0. For example, the mono-denier of the filaments of the front-end plug 33 may be 5.0. Also, a cross-section of the filaments constituting the front-end plug 33 may be a Y shape. Total denier of the front-end plug 33 may be in a range of 20000 to 30000. For example, the total denier of the front-end plug 33 may be within a range of 25000 to 30000. For example, the total denier of the front-end plug 33 may be 28000.

Also, as needed, the front-end plug 33 may include at least one channel. A cross-sectional shape of the channel may be manufactured in various shapes.

The tobacco rod 31 may correspond to the tobacco rod 21 described above with reference to FIG. 4. Therefore, hereinafter, the detailed description of the tobacco rod 31 will be omitted.

The first segment 321 may be formed of cellulous acetate. For example, the first segment 321 may be a tube-type structure having a hollow inside. The first segment 321 may be manufactured by adding a plasticizer (e.g., triacetin) to cellulous acetate tow. For example, mono-denier and total denier of the first segment 321 may be the same as the mono-denier and total denier of the front-end plug 33.

The second segment 322 may be formed of cellulous acetate. Mono denier of filaments constituting the second segment 322 may be in a range of 1.0 to 10.0. For example, the mono denier of the filaments of the second segment 322 may be within a range of about 8.0 to about 10.0. For example, the mono denier of the filaments of the second segment 322 may be 9.0. Also, a cross-section of the filaments of the second segment 322 may be a Y shape. Total denier of the second segment 322 may be in a range of 20000 to 30000. For example, the total denier of the second segment 322 may be 25000.

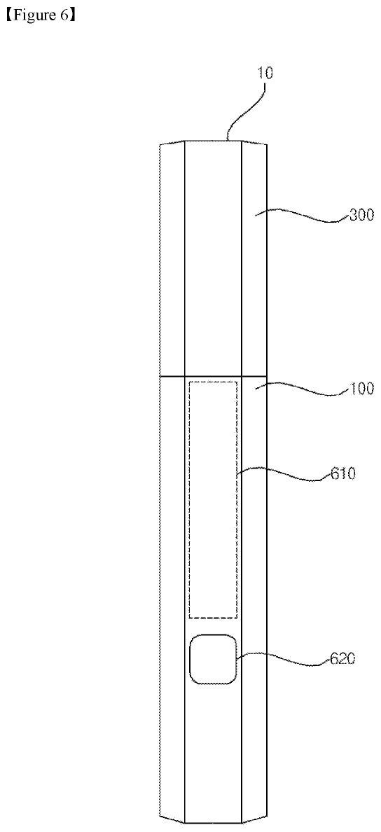

FIG. 6 is a view for explaining the configuration of an aerosol-generating device according to an embodiment of the present disclosure.

Referring to FIG. 6, an aerosol-generating device 10 may include a main body 100 and/or a cap 300. The main body 100 and/or the cap 300 may form the external appearance of the aerosol-generating device 10.

The cap 300 may be coupled to the upper portion of the main body 100. The cap 300 may cover the upper portion of the main body 100. The cap 300 may cover a cartridge 200 disposed on the upper portion of the main body 100. The cap 300 may be separated from the main body 100. When the cap 300 is separated from the main body 100, the upper portion of the main body 100 may be exposed to the outside. The sensor module 15 may include a sensor for detecting coupling and separation of the cap 300 to and from the main body 100 (hereinafter referred to as a cap sensor). For example, the cap sensor may be implemented as a contact sensor, a Hall sensor (Hall IC), a proximity sensor, or the like.

One side of the cap 300 may be open to communicate with the insertion space 130. The cap 300 may include a cover for opening and closing the insertion space 130. The cover may open and close an opening through which the insertion space 130 is exposed to the outside. The opening through which the insertion space 130 is exposed to the outside may be formed in the upper surface of the cap 300. The cover may be movably mounted. The cover may move to open and close the insertion space 130. For example, the cover may slide along the upper surface of the cap 130 in order to open the insertion space 130.

A display 610 and/or a button 620 may be disposed on one side of the main body 100. The button 620 may be inserted into and disposed in an open hole formed in one side of the main body 100. When the user presses the button 620, the button 620 may be moved toward the inside of the main body 100. After being moved to the inside of the main body 100, the button 620 may be moved toward the outside of the main body 100 to return to the original position thereof. The button 620 may be electrically connected to the controller 17. The button 620 may output a signal corresponding to user input of pressing the button 620 (hereinafter referred to as touch input).

The controller 17 may receive a signal output from the button 620. The controller 17 may determine touch input based on a signal output from the button 620. The controller 17 may check the time period for which the touch input is received based on the signal output from the button 620. In this case, the controller 17 may determine the type of user input corresponding to the time period for which the touch input is received. For example, the type of user input corresponding to the time period for which the touch input is received may include a first type corresponding to less than a first time period, a second type corresponding to the first time period or longer but less than a second time period, and a third type corresponding to the second time period or longer.

Meanwhile, in the present disclosure, the button 620 is described as an example of an input device, but the present disclosure is not limited thereto. For example, the input device disposed on one side of the main body 100 may include a capacitive touch sensor, a resistive touch sensor, a surface acoustic wave touch sensor, and an infrared touch sensor.

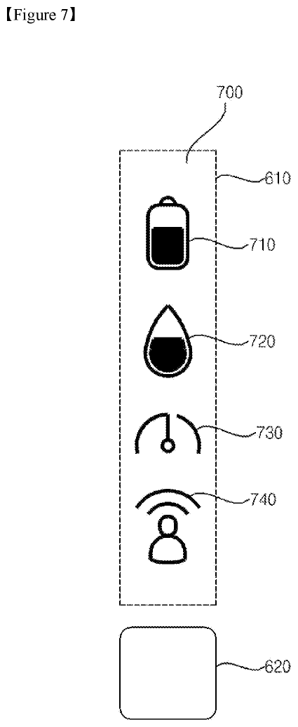

Referring to FIG. 7, the aerosol-generating device 10 may output a home screen 700 through the display 610. For example, the aerosol-generating device 10 may turn on the display 610 when touch input is received through the button 620 in the state in which the display 610 is in an off state. In this case, the home screen 700 may be displayed on the display 610.

The home screen 700 may include at least one indicator. For example, the home screen 700 may include an indicator 710 indicating the state of the battery 16 (hereinafter referred to as a battery indicator), an indicator 720 indicating the amount of the aerosol-generating substance remaining in the cartridge 200 (hereinafter referred to as a cartridge indicator), an indicator 730 indicating the operation mode of the aerosol-generating device 10 (hereinafter referred to as a mode indicator), and an indicator 740 indicating whether control is performed based on a user's use pattern (hereinafter referred to as a pattern control indicator).

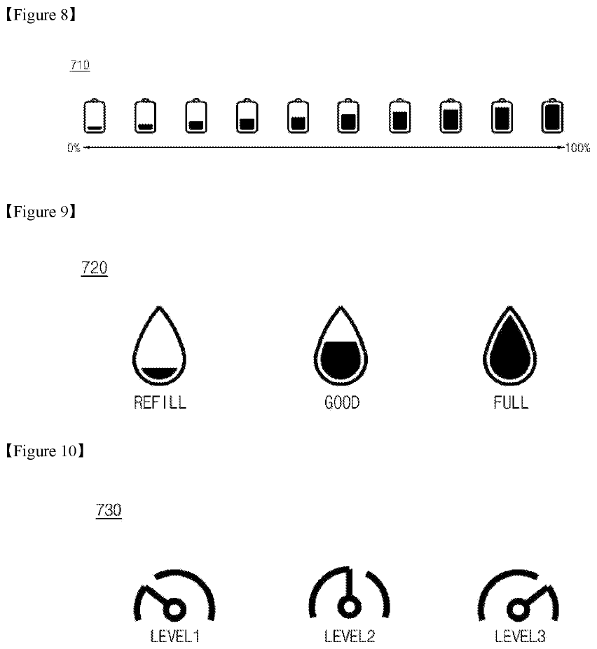

Referring to FIG. 8, the battery indicator 710 may be displayed as any one of a plurality of images corresponding to the remaining amount of power of the battery 16. For example, the battery indicator 710 may be displayed as an image indicating a power amount section corresponding to the current remaining amount of power of the battery 16 among a plurality of images.

Referring to FIG. 9, the cartridge indicator 720 may be displayed as any one of a plurality of images corresponding to the amount of aerosol-generating substance remaining in the cartridge 200. For example, the cartridge indicator 720 may be displayed as any one of an image REFILL indicating a section in which the current remaining amount of aerosol-generating substance is very small, an image GOOD indicating a section in which the current remaining amount of aerosol-generating substance is moderate, and an image FULL indicating a section in which the current remaining amount of aerosol-generating substance is very large.

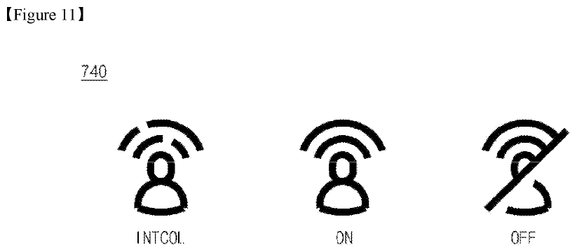

Referring to FIG. 10, the mode indicator 730 may be displayed as any one of a plurality of images indicating a plurality of modes that can be set to an operation mode of the aerosol-generating device 10. For example, the mode indicator 720 may be displayed as an image indicating a mode currently set to an operation mode among a plurality of modes LEVEL 1 to LEVEL 3 that can be set to an operation mode of the aerosol-generating device 10.

Referring to FIG. 11, the pattern control indicator 740 may be displayed as any one of a plurality of images related to a use pattern. For example, the pattern control indicator 740 may be displayed as any one of an image INTCOL indicating collection of data on a use pattern, an image ON indicating application of a use pattern, and an image OFF indicating non-application of a use pattern.

Meanwhile, in the state in which the home screen 700 is displayed on the display 610, the aerosol-generating device 10 may perform operation corresponding to touch input through the button 620. For example, upon receiving input of pressing the button 620 for a predetermined time period or longer in the state in which the home screen 700 is displayed on the display 610, the aerosol-generating device 10 may be powered off. For example, upon receiving input of pressing the button 620 for less than the predetermined time period in the state in which the home screen 700 is displayed on the display 610, the aerosol-generating device 10 may change the screen output on the display 610.

Meanwhile, the aerosol-generating device 10 may generate vibration having less than a predetermined duration once using a motor in response to power-on or power-off of the aerosol-generating device 10.

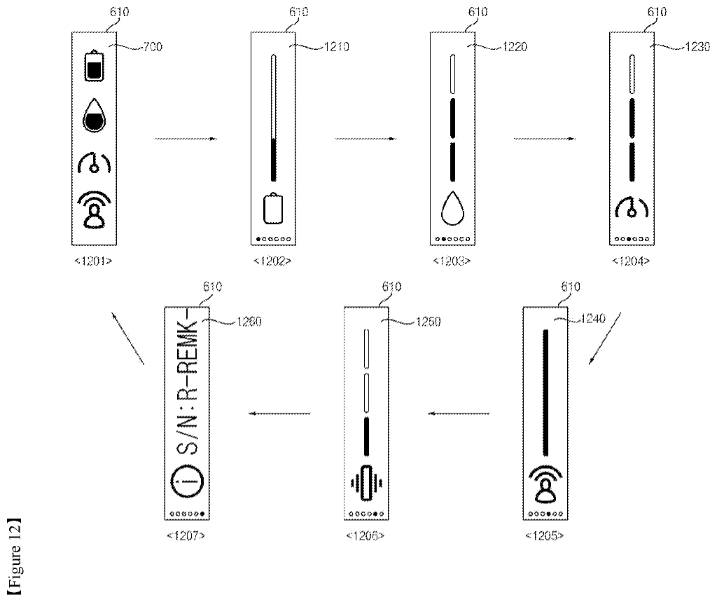

Referring to FIG. 12, upon receiving first-type input of pressing the button 620 for less than a first time period in the state in which the home screen 700 is displayed on the display 610, the aerosol-generating device 10 may change the screens output on the display 610 in predetermined order. For example, upon receiving the first-type input in the state in which the home screen 700 is displayed on the display 610, the aerosol-generating device 10 may change the screen displayed on the display 610 to a detailed screen 1210 related to the battery. In addition, when the first-type input is received, the screen displayed on the display 610 may be sequentially changed to a detailed screen 1220 related to the cartridge 200, a detailed screen 1230 related to the operation mode, a detailed screen 1240 related to control, a detailed screen 1250 related to vibration, and a detailed screen 1260 related to device information. Meanwhile, upon receiving the first-type input in the state in which the detailed screen 1260 related to device information is displayed on the display 610, the aerosol-generating device 10 may change the screen displayed on the display 610 to the home screen 700.

According to an embodiment, when user input through the button 620 is not received for a predetermined time period in the state in which a screen other than the home screen 700 is output on the display 610, the aerosol-generating device 10 may output the home screen 700 on the display 610.

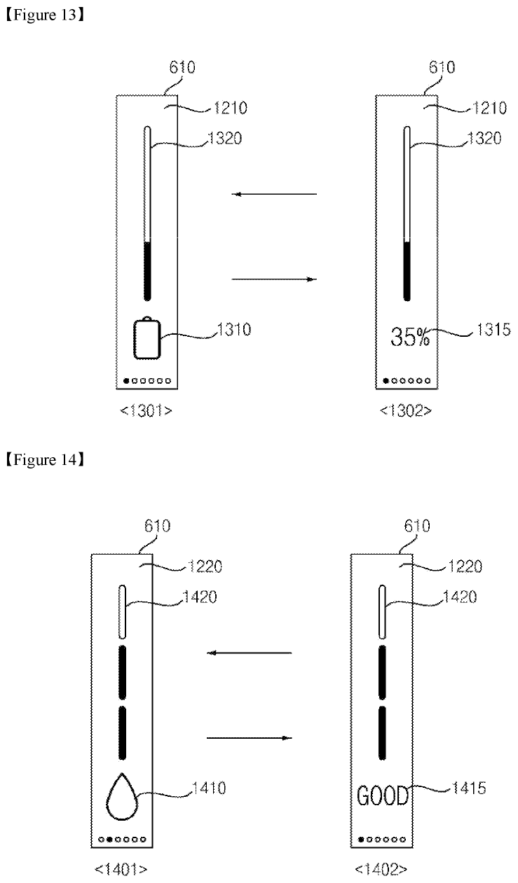

Referring to FIG. 13, the detailed screen 1210 related to the battery may include an indicator 1310 indicating the battery 16 and/or an indicator 1320 indicating the remaining amount of power of the battery 16.

According to an embodiment, the indicators included in the detailed screen 1210 related to the battery may be changed. For example, when a predetermined time period, e.g. 2 seconds, has elapsed from the time point of display of the indicator 1310 indicating the battery 16, an indicator 1315 indicating a numerical value corresponding to the remaining amount of power of the battery 16 may be displayed in place of the indicator 1310 indicating the battery 16. In addition, when a predetermined time period, e.g. 2 seconds, has elapsed from the time point of display of the indicator 1315 indicating a numerical value corresponding to the remaining amount of power of the battery 16, the indicator 1310 indicating the battery 16 may be displayed in place of the indicator 1315 indicating a numerical value corresponding to the remaining amount of power of the battery 16.

Referring to FIG. 14, the detailed screen 1220 related to the cartridge 200 may include an indicator 1410 indicating the liquid-type aerosol-generating substance and/or an indicator 1420 indicating the remaining amount of aerosol-generating substance.

According to an embodiment, the indicators included in the detailed screen 1220 related to the cartridge 200 may be changed. For example, when a predetermined time period, e.g. 2 seconds, has elapsed from the time point of display of the indicator 1410 indicating the aerosol-generating substance, an indicator 1415 indicating the remaining amount of aerosol-generating substance in a text mode may be displayed in place of the indicator 1410 indicating the aerosol-generating substance. In addition, when a predetermined time period, e.g. 2 seconds, has elapsed from the time point of display of the indicator 1415 indicating the remaining amount of aerosol-generating substance in a text mode, the indicator 1410 indicating the aerosol-generating substance may be displayed in place of the indicator 1415 indicating the remaining amount of aerosol-generating substance in a text mode.

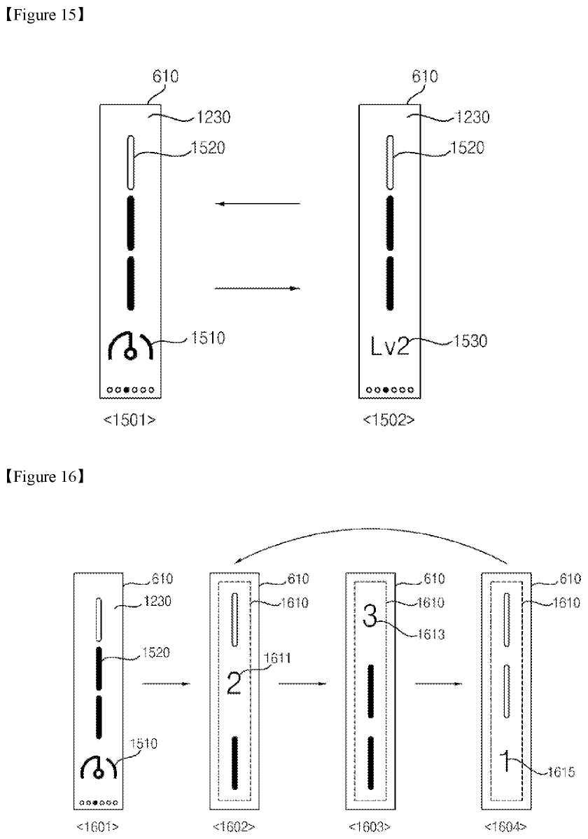

Referring to FIG. 15, the detailed screen 1230 related to the operation mode may include a plurality of indicators 1510 and 1520 indicating the current operation mode.

According to an embodiment, the indicators included in the detailed screen 1230 related to the operation mode may be changed. For example, when a predetermined time period, e.g. 2 seconds, has elapsed from the time point of display of the first indicator 1510 indicating the current operation mode, a third indicator 1530 indicating the current operation mode may be displayed in place of the first indicator 1510 indicating the current operation mode. In addition, when a predetermined time period, e.g. 2 seconds, has elapsed from the time point of display of the third indicator 1530 indicating the current operation mode, the first indicator 1510 indicating the current operation mode may be displayed in place of the third indicator 1530 indicating the current operation mode.

Meanwhile, referring to FIG. 16, upon receiving second-type input of pressing the button 620 for the first time period or longer but less than the second time period in the state in which the detailed screen 1230 related to the operation mode is displayed on the display 610, the aerosol-generating device 10 may output the setting screen 1610 related to the operation mode on the display 610.

The setting screen 1610 related to the operation mode may include indicators 1611, 1613, and 1615, each of which indicates a corresponding one of the plurality of modes. In this case, when the detailed screen 1230 related to the operation mode is switched to the setting screen 1610 related to the operation mode, an indicator indicating a mode currently set to the operation mode may be included. For example, when the setting screen 1610 related to the operation mode is output in the state in which the second mode among the plurality of modes is set to the operation mode of the aerosol-generating device 10, the indicator 1611 indicating the second mode may be included in the setting screen 1610 related to the operation mode.

Upon receiving the first-type input of pressing the button 620 for less than the first time period in the state in which the setting screen 1610 related to the operation mode is displayed on the display 610, the aerosol-generating device 10 may change the indicators included in the setting screen 1610 related to the operation mode in predetermined order. Meanwhile, upon receiving the second-type input in the state in which the setting screen 1610 related to the operation mode is displayed on the display 610, the aerosol-generating device 10 may update the operation mode of the aerosol-generating device 10. For example, upon receiving the second-type input in the state in which the indicator 1613 indicating the third mode is included in the setting screen 1610 related to the operation mode, the aerosol-generating device 10 may change the operation mode of the aerosol-generating device 10 to the third mode.

Meanwhile, the aerosol-generating device 10 may generate vibration having less than a predetermined duration once using the motor in response to the update of setting for the operation mode.

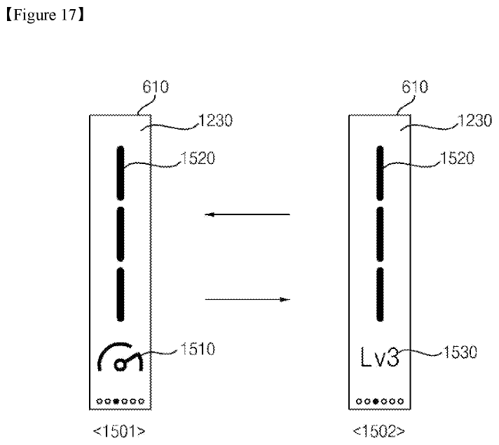

Referring to FIG. 17, upon receiving the second-type input in the state in which the setting screen 1610 related to the operation mode is displayed on the display 610, the aerosol-generating device 10 may again output the detailed screen 1230 related to the operation mode on the display 610. In this case, in response to the change of the operation mode of the aerosol-generating device 10 to the third mode, the plurality of indicators 1510, 1520, and 1530 indicating the current operation mode, which are included in the detailed screen 1230 related to the operation mode, may correspond to the third mode set to the operation mode.

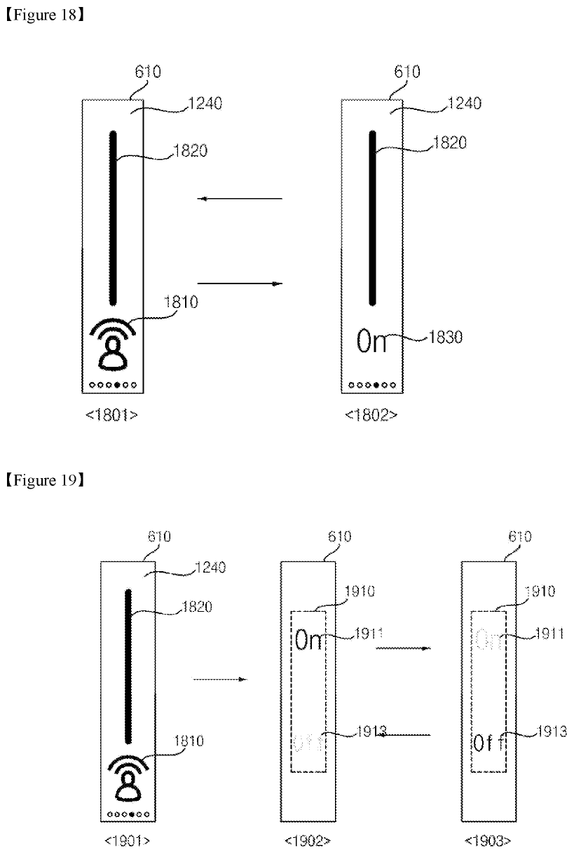

Referring to FIG. 18, the detailed screen 1240 related to control may include a plurality of indicators 1810 and 1820 indicating whether a user's use pattern is being applied.

According to an embodiment, the indicators included in the detailed screen 1240 related to control may be changed. For example, when a predetermined time period, e.g. 2 seconds, has elapsed from the time point of display of the first indicator 1810 indicating whether the use pattern is being applied, a third indicator 1830 indicating whether the use pattern is being applied may be displayed in place of the first indicator 1810 indicating whether the use pattern is being applied. In addition, when a predetermined time period, e.g. 2 seconds, has elapsed from the time point of display of the third indicator 1830 indicating whether the use pattern is being applied, the first indicator 1810 indicating whether the use pattern is being applied may be displayed in place of the third indicator 1830 indicating whether the use pattern is being applied.

Meanwhile, referring to FIG. 19, upon receiving the second-type input of pressing the button 620 for the first time period or longer but less than the second time period in the state in which the detailed screen 1240 related to control is displayed on the display 610, the aerosol-generating device 10 may output the setting screen 1910 related to control on the display 610.

The setting screen 1910 related to control may include an indicator 1911 indicating application of the use pattern and/or an indicator 1913 indicating non-application of the use pattern. In this case, when the detailed screen 1240 related to control is switched to the setting screen 1910 related to control, an indicator corresponding to the currently set item for the use pattern may be displayed separately. For example, when the setting screen 1910 related to control is output in the state in which the current use pattern is set to be applied to control, the indicator 1911 indicating application of the use pattern may be displayed in a relatively dark color.

Upon receiving the first-type input of pressing the button 620 for less than the first time period in the state in which the setting screen 1910 related to control is displayed on the display 610, the aerosol-generating device 10 may change display of the indicators included in the setting screen 1910 related to control. For example, upon receiving the first-type input in the state in which the indicator 1911 indicating application of the use pattern is displayed in a relatively dark color, the indicator 1913 indicating non-application of the use pattern may be displayed in a relatively dark color.

Meanwhile, upon receiving the second-type input in the state in which the setting screen 1910 related to control is displayed on the display 610, the aerosol-generating device 10 may update data on whether the use pattern is applied. For example, the aerosol-generating device 10 may be set not to apply the user's use pattern to control upon receiving the second-type input in the state in which the indicator 1913 indicating non-application of the use pattern is displayed in a relatively dark color.

Meanwhile, the aerosol-generating device 10 may generate vibration having less than a predetermined duration once using the motor in response to the update of setting for the user's use pattern.

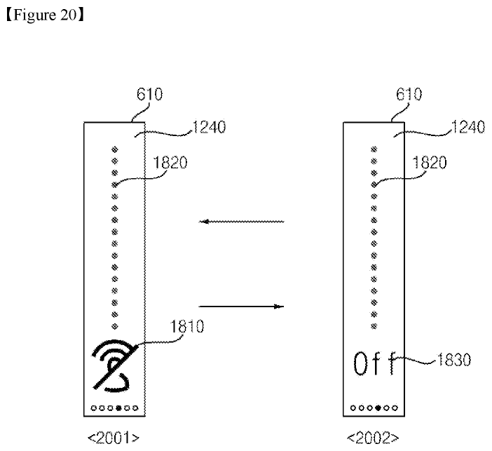

Referring to FIG. 20, upon receiving the second-type input in the state in which the setting screen 1910 related to control is displayed on the display 610, the aerosol-generating device 10 may again output the detailed screen 1240 related to control on the display 610. When it is set that the user's use pattern is not to be applied to control, the plurality of indicators 1810, 1820, and 1830 indicating whether the user's use pattern is applied may correspond to non-application of the use pattern.

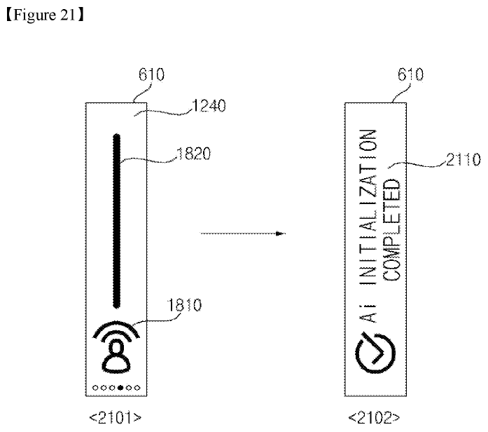

Meanwhile, referring to FIG. 21, the aerosol-generating device 10 may initialize data on the use pattern. For example, upon receiving third-type input of pressing the button 620 for the second time period or longer in the state in which the detailed screen 1240 related to control is displayed on the display 610, the aerosol-generating device 10 may initialize data on the use pattern. In this case, the aerosol-generating device 10 may output a screen 2110 corresponding to initialization of data on the use pattern on the display 610.

Meanwhile, the aerosol-generating device 10 may generate vibration having a predetermined duration or longer once using the motor in response to initialization of data on the use pattern.

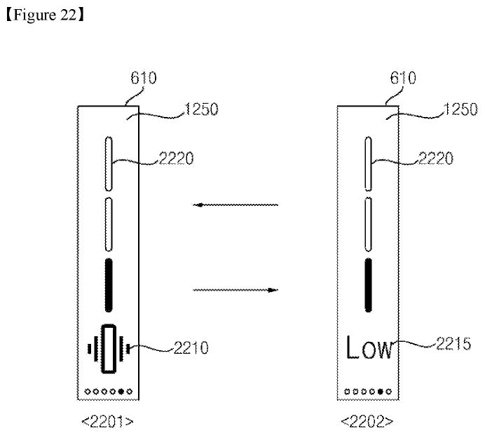

Referring to FIG. 22, the detailed screen 1250 related to vibration may include a plurality of indicators 2210 and 2220 indicating the intensity of vibration.

According to an embodiment, the indicators included in the detailed screen 1250 related to vibration may be changed. For example, when a predetermined time period, e.g. 2 seconds, has elapsed from the time point of display of the first indicator 2210 indicating the current intensity of vibration, a third indicator 2215 indicating the current intensity of vibration may be displayed in place of the first indicator 2210 indicating the current intensity of vibration. In addition, when a predetermined time period, e.g. 2 seconds, has elapsed from the time point of display of the third indicator 2215 indicating the current intensity of vibration, the first indicator 2210 indicating the current intensity of vibration may be displayed in place of the third indicator 2215 indicating the current intensity of vibration.

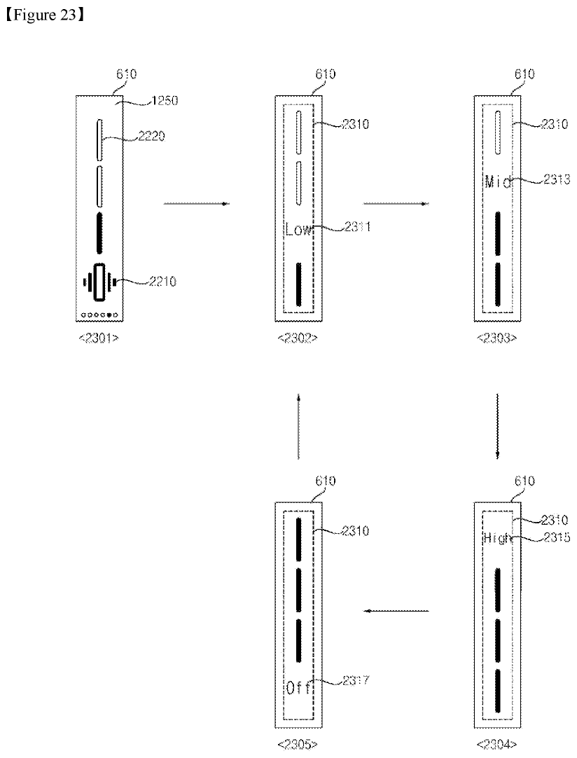

Meanwhile, referring to FIG. 23, upon receiving the second-type input of pressing the button 620 for the first time period or longer but less than the second time period in the state in which the detailed screen 1250 related to vibration is displayed on the display 610, the aerosol-generating device 10 may output a setting screen 2310 related to the intensity of vibration on the display 610.

The setting screen 2310 related to the intensity of vibration may include indicators 2311, 2313, 2315, and 2317, each of which indicates a corresponding one of a plurality of intensities of vibration. In this case, when the detailed screen 1250 related to vibration is switched to the setting screen 2310 related to the intensity of vibration, an indicator indicating the currently set intensity of vibration may be included. For example, when the setting screen 2310 related to vibration is output in the state in which low intensity LOW among the plurality of intensities of vibration is set to the intensity of vibration of the aerosol-generating device 10, the indicator 2311 indicating the low intensity Low may be included in the setting screen 2310 related to the intensity of vibration.

Upon receiving the first-type input of pressing the button 620 for less than the first time period in the state in which the setting screen 2310 related to the intensity of vibration is displayed on the display 610, the aerosol-generating device 10 may change the indicators included in the setting screen 2310 related to the intensity of vibration in predetermined order. Meanwhile, upon receiving the second-type input in the state in which the setting screen 2310 related to the intensity of vibration is displayed on the display 610, the aerosol-generating device 10 may update the intensity of vibration. For example, upon receiving the second-type input in the state in which the indicator 2313 indicating the medium intensity Mid is included in the setting screen 2310 related to the intensity of vibration, the aerosol-generating device 10 may change the intensity of vibration of the aerosol-generating device 10 to the medium intensity Mid.

Meanwhile, the aerosol-generating device 10 may generate vibration having less than a predetermined duration once using the motor in response to the update of setting for vibration.

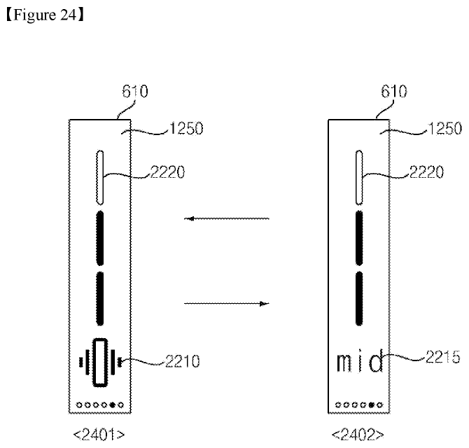

Referring to FIG. 24, upon receiving the second-type input in the state in which the setting screen 2310 related to the intensity of vibration is displayed on the display 610, the aerosol-generating device 10 may again output the detailed screen 1250 related to the intensity of vibration on the display 610. In this case, in response to the change of the intensity of vibration of the aerosol-generating device 10, the plurality of indicators 2210, 2215, and 2220 indicating the intensity of vibration, which are included in the detailed screen 1250 related to the intensity of vibration, may correspond to the medium intensity Mid set to the intensity of vibration.

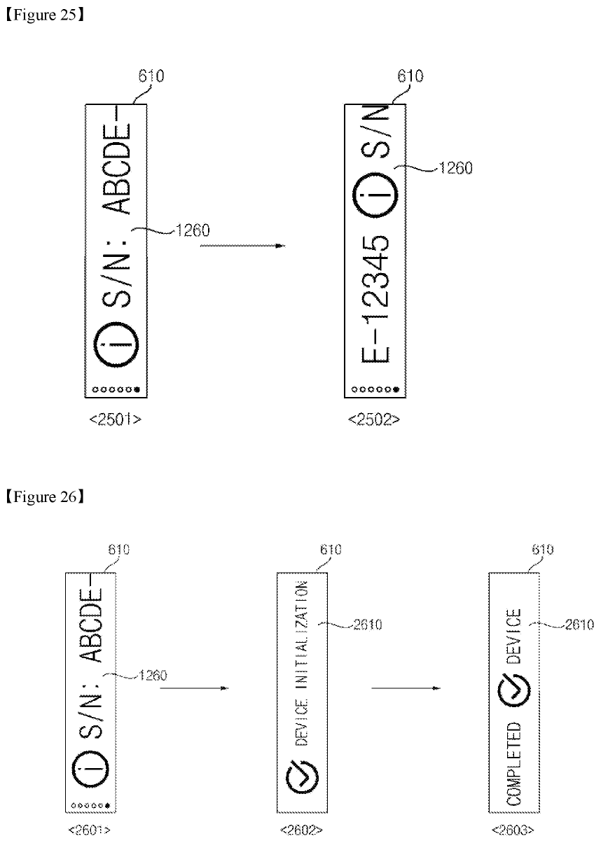

Referring to FIG. 25, the detailed screen 1260 related to device information may include device information 2510 about the aerosol-generating device 10. For example, the device information 2510 may include the serial number of the aerosol-generating device 10. In this case, when all of the device information 2510 is not displayed on the detailed screen 1260 related to device information, for example, when only a part of the device information 2510 is displayed on the detailed screen 1260 related to device information, all of the parts of the device information 2510 may be sequentially displayed on the detailed screen 1260 related to device information. For example, a part of the device information 2510 displayed on the detailed screen 1260 related to device information may be removed therefrom, and the remaining part of the device information 2510 that has not been displayed may be displayed on the detailed screen 1260 related to device information.

Meanwhile, referring to FIG. 26, the aerosol-generating device 10 may initialize data on a user set in the aerosol-generating device 10. Here, the data on a user may include settings for an operation mode, whether to apply a use pattern, and the intensity of vibration. For example, upon receiving the third-type input of pressing the button 620 for the second time period or longer in the state in which the detailed screen 1260 related to device information is displayed on the display 610, the aerosol-generating device 10 may initialize settings for an operation mode, whether to apply a use pattern, and the intensity of vibration.

The aerosol-generating device 10 may output a screen 2610 corresponding to the initialization of the data on a user on the display 610 in response to the initialization of the data on a user set in the aerosol-generating device 10. Meanwhile, the aerosol-generating device 10 may generate vibration having a predetermined duration or longer once using the motor in response to the initialization of the data on a user set in the aerosol-generating device 10.

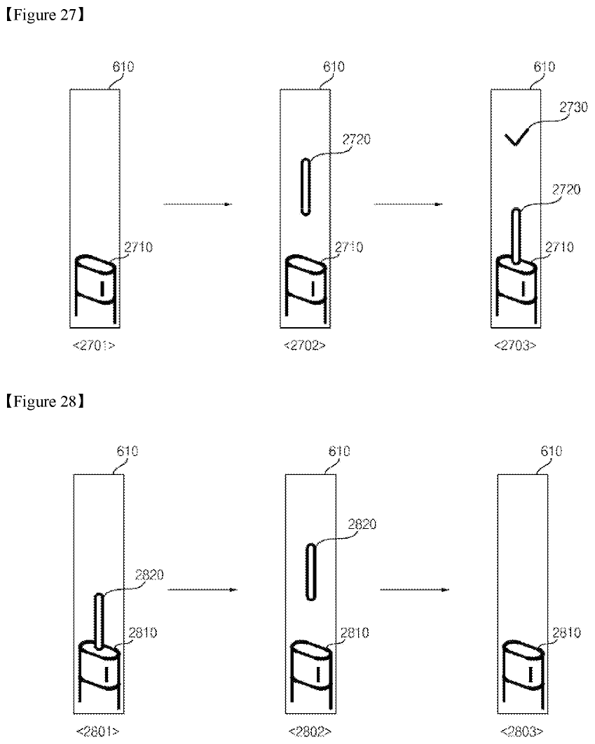

Referring to FIG. 27, the aerosol-generating device 10 may output a screen indicating insertion of the stick 20 in response to insertion of the stick 20 in a normal state. Upon detecting insertion of the stick 20 in a normal state using the stick detection sensor, the aerosol-generating device 10 may output an image 2710 corresponding to the aerosol-generating device 10 on the display 610. In addition, the aerosol-generating device 10 may additionally output an image 2720 corresponding to the stick 20 in the state in which the image 2710 corresponding to the aerosol-generating device 10 is output on the display 610. In addition, the aerosol-generating device 10 may change the positions of the image 2710 corresponding to the aerosol-generating device 10 and the image 2720 corresponding to the stick 20 on the display 610 such that the two images 2710 and 2720 approach each other, and may also output an image 2730 corresponding to completion of operation.

Meanwhile, upon detecting insertion of the stick 20 in a normal state, the aerosol-generating device 10 may generate vibration having a predetermined duration or longer once using the motor.

Referring to FIG. 28, the aerosol-generating device 10 may output a screen indicating removal of the stick 20 in response to removal of the stick 20. Upon detecting removal of the stick 20 using the stick detection sensor, the aerosol-generating device 10 may output an image 2810 corresponding to the aerosol-generating device 10 and an image 2820 corresponding to the stick 20 on the display 610 such that the two images 2810 and 2820 are located adjacent to each other. In addition, the aerosol-generating device 10 may change the positions of the image 2810 corresponding to the aerosol-generating device 10 and the image 2820 corresponding to the stick 20 on the display 610 such that the two images 2810 and 2820 move away from each other. In addition, the aerosol-generating device 10 may remove the image 2820 corresponding to the stick 20 from the screen output on the display 610.

Meanwhile, the aerosol-generating device 10 may generate vibration having less than a predetermined duration three times using the motor in response to removal of the stick 20.

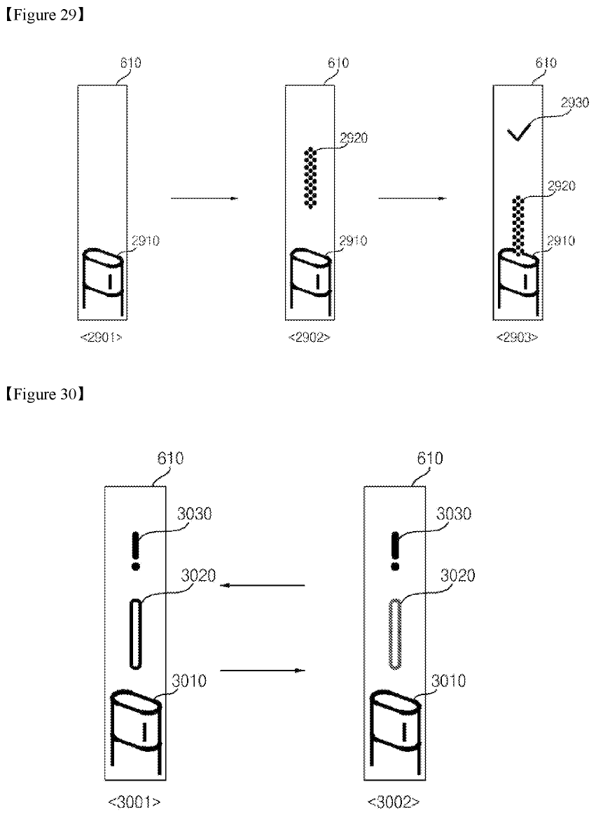

Referring to FIG. 29, the aerosol-generating device 10 may output a screen indicating insertion of the stick 20 containing an excessive amount of moisture in response to insertion of the stick 20 containing an excessive amount of moisture. For example, when variation in the level of the signal from the stick detection sensor, which is implemented as a capacitance sensor, is equal to or greater than a predetermined maximum level, the aerosol-generating device 10 may determine that the stick 20 containing an excessive amount of moisture has been inserted.

Upon detecting insertion of the stick 20 containing an excessive amount of moisture, the aerosol-generating device 10 may output an image 2910 corresponding to the aerosol-generating device 10 on the display 610. In addition, the aerosol-generating device 10 may additionally output an image 2920 corresponding to the stick 20 containing an excessive amount of moisture in the state in which the image 2910 corresponding to the aerosol-generating device 10 is output on the display 610. In addition, the aerosol-generating device 10 may change the positions of the image 2910 corresponding to the aerosol-generating device 10 and the image 2920 corresponding to the stick 20 containing an excessive amount of moisture on the display 610 such that the two images 2910 and 2920 approach each other, and may also output an image 2930 corresponding to completion of operation. Meanwhile, the color of the image 2920 corresponding to the stick 20 containing an excessive amount of moisture may be a predetermined color (e.g. blue) corresponding to the stick 20 containing an excessive amount of moisture.

Meanwhile, the aerosol-generating device 10 may generate vibration having less than a predetermined duration three times using the motor in response to insertion of the stick 20 containing an excessive amount of moisture.

Referring to FIG. 30, upon detecting insertion of the stick 20 in an abnormal state, the aerosol-generating device 10 may output a screen indicating insertion of the stick 20 in an abnormal state. For example, in response to a signal from the stick detection sensor, which is implemented as an inductance sensor, the aerosol-generating device 10 may determine the kind of metal included in the stick 20 corresponding to an inductance value. When the kind of metal included in the stick 20 is different from a predetermined kind, the aerosol-generating device 10 may determine that the stick 20 that has been inserted is in an abnormal state.

Meanwhile, the aerosol-generating device 10 may generate vibration having less than a predetermined duration three times using the motor in response to insertion of the stick 20 in an abnormal state.

Upon detecting insertion of the stick 20 in an abnormal state, the aerosol-generating device 10 may output an image 3010 corresponding to the aerosol-generating device 10, an image 3020 corresponding to the stick 20, and/or an image 3030 corresponding to warning on the display 610. In addition, the aerosol-generating device 10 may repeatedly display and remove the image 3020 corresponding to the stick 20 on and from the display 610 at a predetermined time interval. Meanwhile, the color of the image 3020 corresponding to the stick 20 in an abnormal state may be a predetermined color (e.g. red) corresponding to the stick 20 in an abnormal state.

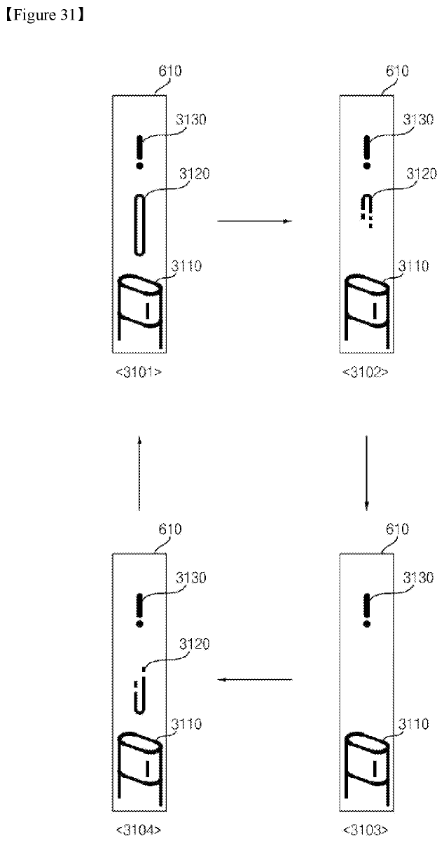

Referring to FIG. 31, upon detecting insertion of a used stick 20, the aerosol-generating device 10 may output a screen indicating insertion of the used stick 20. For example, when an aerosol is generated through the stick 20, at least a portion of the wrapper 24 of the stick 20 may become discolored. In this case, the aerosol-generating device 10 may determine whether the stick 20 is a used stick using an optical sensor, which detects the color of the portion of the wrapper 24 that discolors.

Upon detecting insertion of the used stick 20, the aerosol-generating device 10 may output an image 3110 corresponding to the aerosol-generating device 10, an image 3120 corresponding to the stick 20, and/or an image 3130 corresponding to warning on the display 610. In addition, the aerosol-generating device 10 may repeatedly display and remove the image 3120 corresponding to the stick 20 on and from the display 610 at a predetermined time interval. Meanwhile, the color of the image 3120 corresponding to the used stick 20 may be a predetermined color (e.g. orange) corresponding to the used stick 20.

Meanwhile, the aerosol-generating device 10 may generate vibration having less than a predetermined duration three times using the motor in response to insertion of the used stick 20.

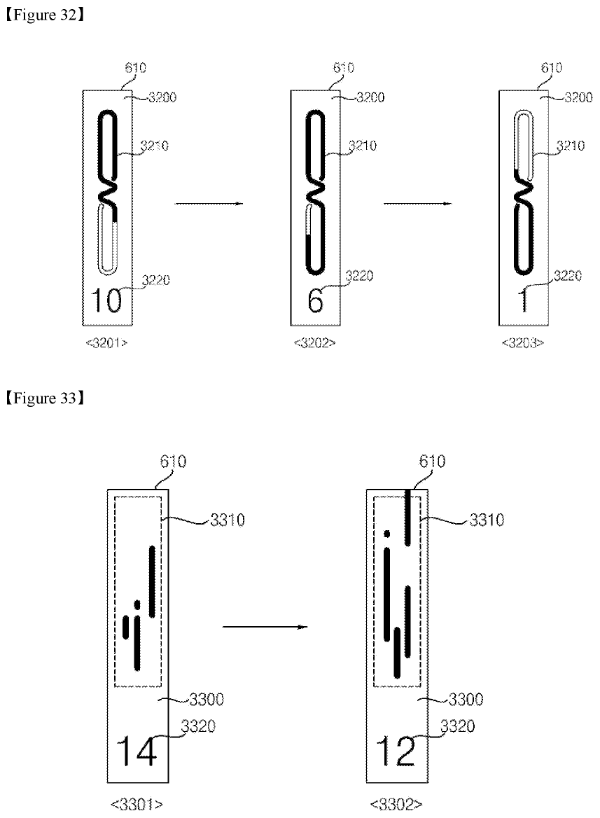

Referring to FIG. 32, the aerosol-generating device 10 may output a screen 3200 related to execution of operation of preheating the heater 110 (hereinafter referred to as a preheating screen) on the display 610. For example, upon detecting insertion of the stick 20 in a normal state, the aerosol-generating device 10 may perform preheating of the heater 110 based on a temperature profile stored in the memory 14. In this case, the aerosol-generating device 10 may output the preheating screen 3200, which includes an image 3210 corresponding to preheating and/or an image 3220 corresponding to the time remaining until the end of preheating, on the display 610.

According to an embodiment, as time passes from the time point of start of preheating, the area of a portion of the image 3210 corresponding to preheating, which is displayed in a predetermined color (e.g. red), may be changed. Meanwhile, as time passes from the time point of start of preheating, the image 3220 corresponding to the time remaining until the end of preheating may be changed according to the time period for which preheating has been performed.

Meanwhile, the aerosol-generating device 10 may generate vibration having a predetermined duration or longer once using the motor in response to start and/or termination of operation of preheating heater 110.

Referring to FIG. 33, the aerosol-generating device 10 may output a screen 3300 related to execution of operation of heating the heater 110 to generate an aerosol (hereinafter referred to as a heating screen) on the display 610. For example, when preheating of the heater 110 is completed, the aerosol-generating device 10 may perform heating of the heater 110 based on the temperature profile stored in the memory 14. In this case, the aerosol-generating device 10 may output the heating screen 3300, which includes an image 3310 corresponding to an aerosol and/or an image 3320 corresponding to the remaining number of puffs, on the display 610. Meanwhile, as time passes from the time point of start of generation of an aerosol, the image 3310 corresponding to an aerosol may be continuously changed.

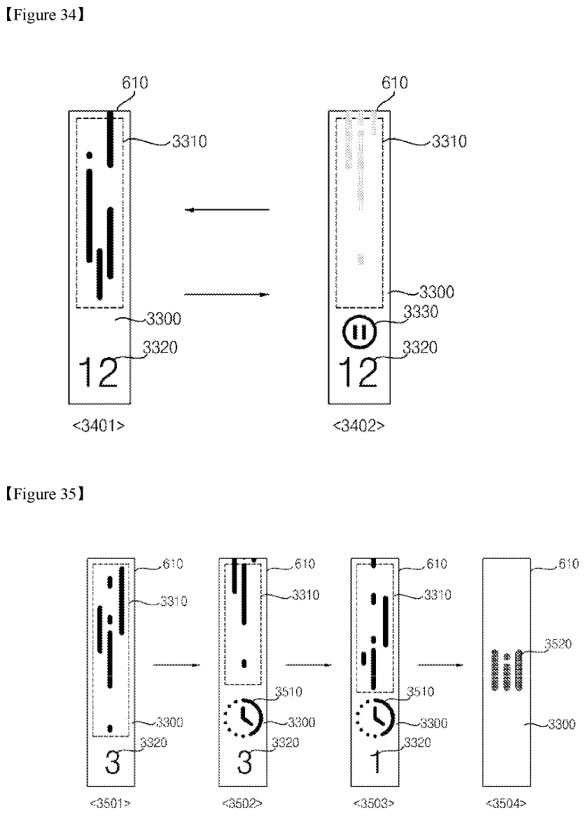

Referring to FIG. 34, the aerosol-generating device 10 may additionally output an image 3330 corresponding to pause of generation of an aerosol in response to pause of operation of generating an aerosol. For example, upon receiving the first-type input of pressing the button 620 for less than the first time period, the aerosol-generating device 10 may pause operation of generating an aerosol. In this case, the change of the image 3310 corresponding to an aerosol may also be paused. Meanwhile, the aerosol-generating device 10 may generate vibration having less than a predetermined duration once using the motor in response to pause of operation of generating an aerosol.

Meanwhile, upon receiving the first-type input of pressing the button 620 for less than the first time period in the state in which the operation of generating an aerosol is paused, the aerosol-generating device 10 may again perform the operation of generating an aerosol. In this case, the aerosol-generating device 10 may remove the image 3330 corresponding to pause of generation of an aerosol from the heating screen 3330. In addition, as time passes from the time point of restart of generation of an aerosol, the image 3310 corresponding to an aerosol may be continuously changed again.

Referring to FIG. 35, the aerosol-generating device 10 may additionally output an image 3510 corresponding to the time remaining until generation of an aerosol based on the predetermined time limit for heating of the heater 110. For example, the time limit for heating of the heater 110 with respect to one stick 20 may be set to 2 minutes. In this case, when a predetermined time period, e.g. 1 minute 30 seconds, has elapsed from the time point of start of heating of the heater 110, the aerosol-generating device 10 may display the image 3510 corresponding to the time remaining until generation of an aerosol on the heating screen 3300.

Meanwhile, when a predetermined time period, e.g. 1 minute 30 seconds, has elapsed from the time point of start of heating of the heater 110, the aerosol-generating device 10 may generate vibration having less than a predetermined duration twice using the motor.

Meanwhile, the aerosol-generating device 10 may display an image 3520 corresponding to the device on the heating screen 3300 in response to completion of the operation of generating an aerosol. In this case, the image 3310 corresponding to an aerosol, the image 3320 corresponding to the remaining number of puffs, and/or the image 3510 corresponding to the time remaining until generation of an aerosol may be removed from the heating screen 3300. For example, when the remaining number of puffs is 0, and/or when the time remaining until generation of an aerosol is 0 seconds, the aerosol-generating device 10 may terminate the operation of generating an aerosol. Meanwhile, the aerosol-generating device 10 may interrupt the supply of power to the heater 110 in response to completion of the operation of generating an aerosol.

Meanwhile, when the remaining number of puffs is less than a predetermined number, the aerosol-generating device 10 may generate vibration having less than a predetermined duration twice using the motor. Meanwhile, the aerosol-generating device 10 may generate vibration having a predetermined duration or longer once using the motor in response to completion of the operation of generating an aerosol.

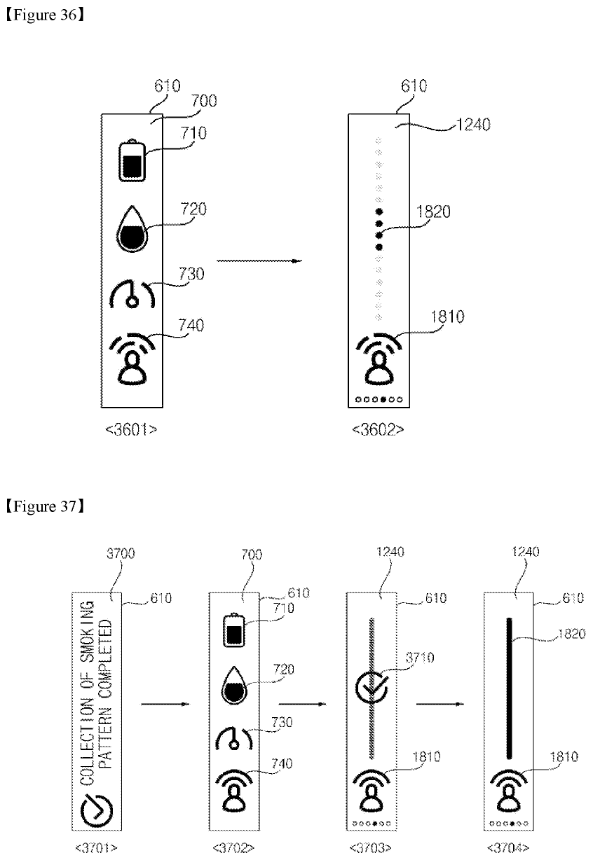

Referring to FIG. 36, when the home screen 700 is output in the state in which the aerosol-generating device 10 collects data on the use pattern, the pattern control indicator 740 included in the home screen 700 may be displayed as an image indicating collection of data on the use pattern. Here, the state of collecting data on the use pattern may correspond to a case in which data on the predetermined number of puffs is not stored in the memory 14 in the state in which the use pattern is set to be applied.

Meanwhile, when the aerosol-generating device 10 outputs the detailed screen 1240 related to control on the display 610 in the state in which the aerosol-generating device 10 collects data on the use pattern, the plurality of indicators 1810 and 1820 indicating whether the use pattern is being applied may correspond to collection of data on the use pattern.

Referring to FIG. 37, the aerosol-generating device 10 may output a screen 3700 related to completion of collection of data on the use pattern on the display 610 in response to completion of collection of data on the use pattern. For example, when data on a predetermined number of sticks 20 is stored in the memory 14, the aerosol-generating device 10 may determine that collection of data on the use pattern is completed. Here, the data on the stick 20 may include the time at which each puff is detected and an interval between puffs.

Meanwhile, the aerosol-generating device 10 may generate vibration having a predetermined duration or longer once using the motor in response to completion of collection of data on the use pattern.

When the home screen 700 is output in the state in which collection of data on the use pattern is completed, the pattern control indicator 740 included in the home screen 700 may be displayed as an image indicating application of the use pattern.

When the aerosol-generating device 10 initially outputs the detailed screen 1240 related to control on the display 610 after collection of data on the use pattern is completed, an image 3710 indicating completion of operation may be included in the detailed screen 1240 related to control. Meanwhile, when a predetermined time period, e.g. 2 seconds, has elapsed from the time point of display of the detailed screen 1240 related to control, the image 3710 indicating completion of operation may be removed from the detailed screen 1240 related to control.

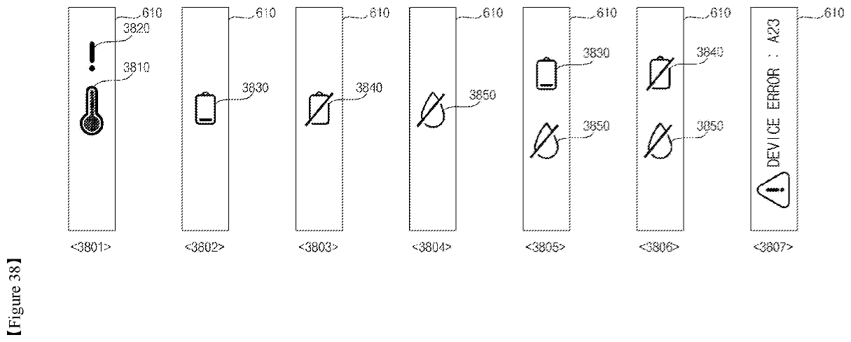

Referring to FIG. 38, the aerosol-generating device 10 may output various screens related to error states on the display 610. Meanwhile, the aerosol-generating device 10 may generate vibration having less than a predetermined duration three times using the motor in response to generation of the error states.

When the temperature of the heater 110 exceeds a predetermined temperature, the aerosol-generating device 10 may output a screen 3801, which includes an image 3810 corresponding to overheating of the heater 110 and/or an image 3820 corresponding to warning, on the display 610. Meanwhile, the aerosol-generating device 10 may repeatedly display and remove the image 3810 corresponding to overheating on and from the display 610 at a predetermined time interval.

When the remaining amount of power of the battery 16 is less than a predetermined first amount of power, the aerosol-generating device 10 may output a screen 3802, which includes an image 3830 corresponding to power shortage in the battery 16, on the display 610.

When the remaining amount of power of the battery 16 is less than a second amount of power, which is less than the first amount of power, the aerosol-generating device 10 may output a screen 3803, which includes an image 3840 corresponding to complete consumption of power of the battery 16, on the display 610.

When the amount of aerosol-generating substance remaining in the cartridge 200 is less than a predetermined amount, the aerosol-generating device 10 may output a screen 3804, which includes an image 3850 corresponding to complete consumption of the liquid-type aerosol-generating substance, on the display 610.

When the remaining amount of power of the battery 16 is less than the predetermined first amount of power and when the amount of aerosol-generating substance remaining in the cartridge 200 is less than the predetermined amount, the aerosol-generating device 10 may output a screen 3805, which includes the image 3830 corresponding to power shortage in the battery 16 and the image 3850 corresponding to complete consumption of the liquid-type aerosol-generating substance, on the display 610.

When the remaining amount of power of the battery 16 is less than the predetermined second amount of power and when the amount of aerosol-generating substance remaining in the cartridge 200 is less than the predetermined amount, the aerosol-generating device 10 may output a screen 3806, which includes the image 3840 corresponding to complete consumption of power of the battery 16 and the image 3850 corresponding to complete consumption of the liquid-type aerosol-generating substance, on the display 610.

The aerosol-generating device 10 may output a screen 3807, which includes an image corresponding to occurrence of an error, on the display 610 in response to occurrence of an error related to the device. For example, when a 23^{rd}-type error among a plurality of errors related to the device occurs, a screen including an image corresponding to occurrence of the 23^{rd}-type error may be output.

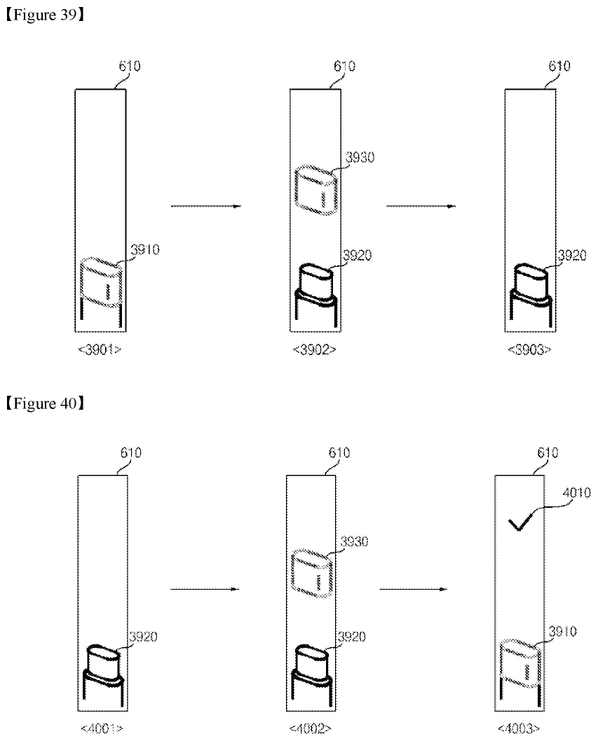

Referring to FIG. 39, the aerosol-generating device 10 may output a screen indicating separation of the cap 300 on the display 610 in response to separation of the cap 300. Upon detecting separation of the cap 300 using the cap sensor, the aerosol-generating device 10 may output an image 3910 corresponding to the aerosol-generating device 10 on the display 610. Meanwhile, the aerosol-generating device 10 may generate vibration having less than a predetermined duration three times using the motor in response to separation of the cap 300.

In addition, an image 3930 corresponding to the cap 300 may be separated from the image 3910 corresponding to the aerosol-generating device 10. In this case, an image 3920 corresponding to the main body 100 may be displayed in place of the image 3910 corresponding to the aerosol-generating device 10 in response to separation of the image 3930 corresponding to the cap 300. Meanwhile, the aerosol-generating device 10 may change the positions of the image 3920 corresponding to the main body 100 and the image 3930 corresponding to the cap 300 on the display 610 such that the two images 3920 and 3930 move away from each other. In addition, the aerosol-generating device 10 may remove the image 3930 corresponding to the cap 300 from the screen output on the display 610.

Referring to FIG. 40, the aerosol-generating device 10 may output a screen indicating coupling of the cap 300 on the display 610 in response to coupling of the cap 300. Upon detecting coupling of the cap 300 using the cap sensor, the aerosol-generating device 10 may output an image 3920 corresponding to the main body 100 on the display 610. In addition, the aerosol-generating device 10 may additionally output the image corresponding to the cap 300 in the state in which the image 3920 corresponding to the main body 100 is output on the display 610. In addition, the aerosol-generating device 10 may change the positions of the image 3920 corresponding to the main body 100 and the image 3930 corresponding to the cap 300 on the display 610 such that the two images 3920 and 3930 approach each other. In addition, the aerosol-generating device 10 may output the image 3910 corresponding to the aerosol-generating device 10 and an image 4010 corresponding to completion of operation in response to overlapping between the image corresponding to the main body 100 and the image 3930 corresponding to the cap 300 on the display 610.

Meanwhile, the aerosol-generating device 10 may generate vibration having a predetermined duration or longer once using the motor upon detecting coupling of the cap 300 using the cap sensor.

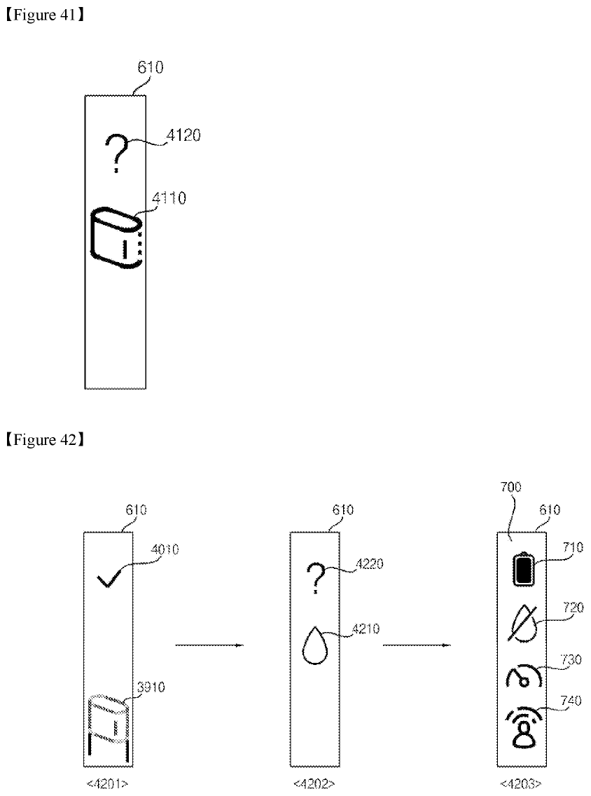

Referring to FIG. 41, the aerosol-generating device 10 may output a screen indicating non-coupling of the cap 300 on the display 610 in response to non-coupling of the cap 300. For example, when a predetermined time period has elapsed from the time point of detection of separation of the cap 300, the aerosol-generating device 10 may determine that the cap 300 has not been coupled. Meanwhile, the aerosol-generating device 10 may generate vibration having less than a predetermined duration three times using the motor in response to non-coupling of the cap 300.

The aerosol-generating device 10 may output a screen, which includes an image 4110 corresponding to the cap 300 and/or an image 4120 corresponding to non-coupling of the cap 300, on the display 610. Meanwhile, the aerosol-generating device 10 may repeatedly display and remove the image 4110 corresponding to the cap 300 on and from the display 610 at a predetermined time interval.

Referring to FIG. 42, the aerosol-generating device 10 may output a screen indicating non-coupling of the cartridge 200 on the display 610 in response to non-coupling of the cartridge 200 to the main body 100. For example, upon detecting coupling of the cap 300 in the state in which the cartridge 200 is separated from the main body 100, the aerosol-generating device 10 may determine that the cartridge 200 has not been coupled to the main body 100.

The aerosol-generating device 10 may output a screen, which includes the image 3910 corresponding to the aerosol-generating device 10 and the image 4010 corresponding to completion of operation, in response to coupling of the cap 300. In this case, upon determining that the cartridge 200 has not been coupled to the main body 100, the aerosol-generating device 10 may output a screen, which includes an image 4210 corresponding to the liquid-type aerosol-generating substance and/or an image 4220 corresponding to non-coupling of the cartridge 200, on the display 610. Meanwhile, when the home screen 700 is output in the state in which the cartridge 200 is not coupled to the main body 100, the cartridge indicator 720 included in the home screen 700 may be displayed as an image indicating the absence of the cartridge 200.

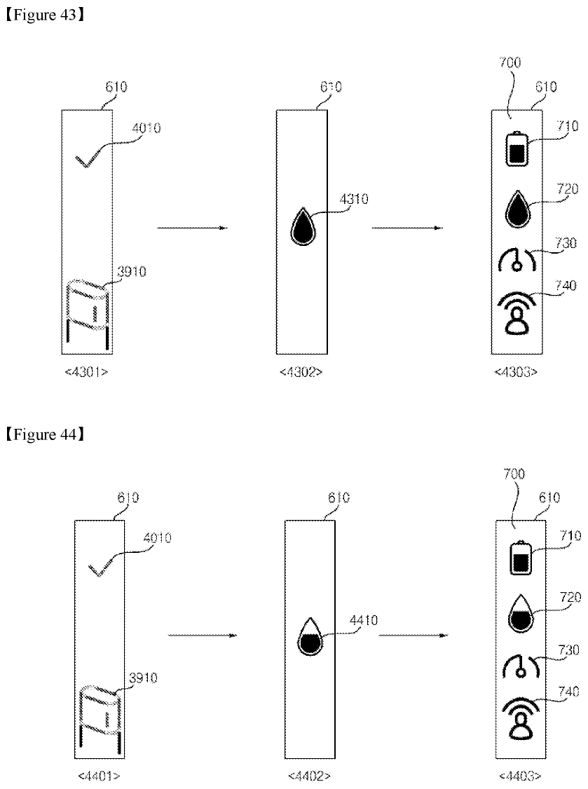

Referring to FIG. 43, the aerosol-generating device 10 may output a screen indicating the amount of aerosol-generating substance remaining in the cartridge 200 in response to coupling of the cartridge 200 to the main body 100. For example, the aerosol-generating device 10 may detect the amount of aerosol-generating substance remaining in the cartridge 200 using the remaining amount detection sensor in response to insertion of the cartridge 200 into the main body 100.

Meanwhile, the aerosol-generating device 10 may generate vibration having a predetermined duration or longer once using the motor in response to coupling of the cartridge 200 to the main body 100.

The aerosol-generating device 10 may output a screen, which includes the image 3910 corresponding to the aerosol-generating device 10 and the image 4010 corresponding to completion of operation, in response to coupling of the cap 300. In this case, upon determining that the cartridge 200 coupled to the main body 100 contains a sufficient amount of aerosol-generating substance, the aerosol-generating device 10 may output a screen, which includes an image 4310 corresponding to a section in which the remaining amount of aerosol-generating substance is very large, on the display 610. Meanwhile, when the home screen 700 is output in the state in which the cartridge 200 containing a sufficient amount of aerosol-generating substance is coupled, the cartridge indicator 720 included in the home screen 700 may be displayed as the image FULL indicating a section in which the remaining amount of aerosol-generating substance is very large.

Meanwhile, referring to FIG. 44, upon determining that the cartridge 200 containing a moderate amount of aerosol-generating substance has been coupled, the aerosol-generating device 10 may output a screen, which includes an image 4410 corresponding to a section in which the remaining amount of aerosol-generating substance is moderate, on the display 610. Meanwhile, when the home screen 700 is output in the state in which the cartridge 200 containing a moderate amount of aerosol-generating substance is coupled, the cartridge indicator 720 included in the home screen 700 may be displayed as the image GOOD indicating a section in which the remaining amount of aerosol-generating substance is moderate.

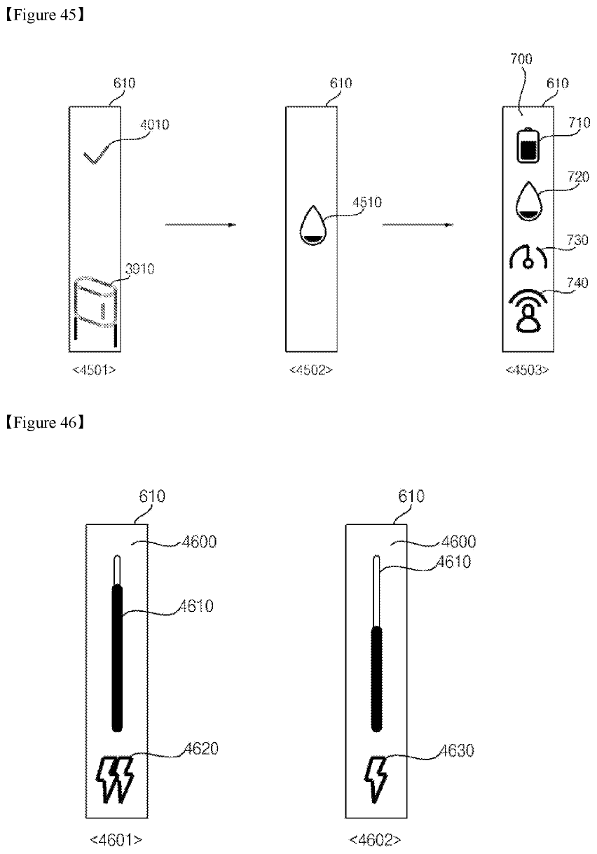

Meanwhile, referring to FIG. 45, upon determining that the cartridge 200 containing an insufficient amount of aerosol-generating substance has been coupled, the aerosol-generating device 10 may output a screen, which includes an image 4510 corresponding to a section in which the remaining amount of aerosol-generating substance is very small, on the display 610. Meanwhile, when the home screen 700 is output in the state in which the cartridge 200 containing an insufficient amount of aerosol-generating substance is coupled, the cartridge indicator 720 included in the home screen 700 may be displayed as the image REFILL indicating a section in which the remaining amount of aerosol-generating substance is very small.

Referring to FIG. 46, the aerosol-generating device 10 may output a screen 4600 related to a charging mode in response to charging of the battery 16. For example, the aerosol-generating device 10 may output the screen 4600 related to the charging mode in response to connection of a power line to a charging terminal provided in the housing 101. Meanwhile, the aerosol-generating device 10 may generate vibration having less than a predetermined duration once using the motor in response to connection of the power line to the charging terminal provided in the housing 101.

The charging mode may include a fast charging mode, a normal charging mode, and/or a communication mode. The fast charging mode may be a mode in which high power greater than or equal to a predetermined reference level is supplied from the outside. The normal charging mode may be a mode in which low power less than the predetermined reference level is supplied from the outside. The communication mode may be a mode in which the aerosol-generating device 10 communicates with an external device using the power line connected to the charging terminal.

When the charging mode of the aerosol-generating device 10 is the fast charging mode, the screen 4600 related to a charging mode output on the display 610 may include an image 4610 corresponding to the remaining amount of power of the battery 16 and/or an image 4620 corresponding to the fast charging mode (4601). Meanwhile, when the charging mode of the aerosol-generating device 10 is the normal charging mode, the screen 4600 related to a charging mode output on the display 610 may include the image 4610 corresponding to the remaining amount of power of the battery 16 and/or an image 4630 corresponding to the normal charging mode (4602).

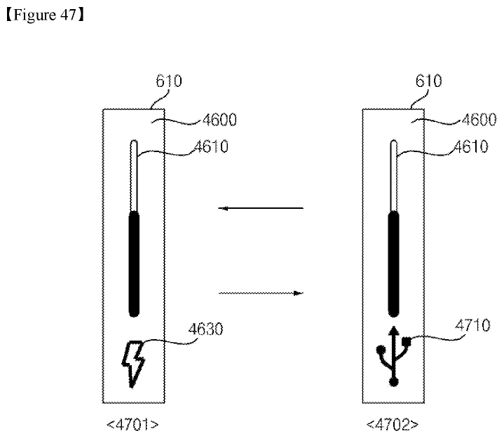

Referring to FIG. 47, upon receiving the first-type input of pressing the button 620 for less than the first time period in the state in which the charging mode is the normal charging mode, the aerosol-generating device 10 may change the charging mode to the communication mode. In this case, an image 4710 corresponding to the communication mode may be displayed in place of the image 4630 corresponding to the normal charging mode on the screen 4600 related to a charging mode based on settings for the communication mode. For example, when the first-type input is received a predetermined number of times, e.g. three times, in the state in which the charging mode is the normal charging mode, the aerosol-generating device 10 may change the charging mode to the communication mode.

Meanwhile, upon receiving the first-type input of pressing the button 620 for less than the first time period in the state in which the charging mode is the communication mode, the aerosol-generating device 10 may change the charging mode to the normal charging mode. In this case, the image 4630 corresponding to the normal charging mode may be displayed in place of the image 4710 corresponding to the communication mode on the screen 4600 related to a charging mode based on settings for the normal charging mode.

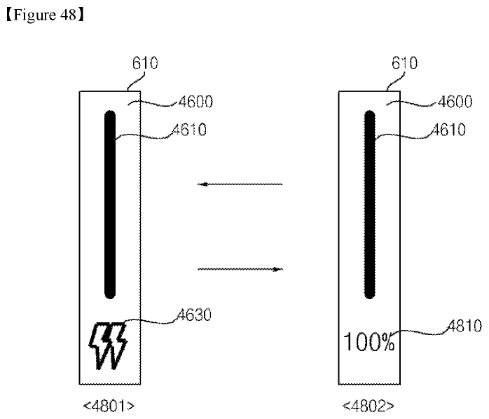

Referring to FIG. 48, when the battery 16 is charged to a predetermined maximum level, an image 4810 corresponding to completion of charging of the battery 16 may be included in the screen 4600 related to a charging mode. For example, when the battery 16 is charged to the predetermined maximum level in the state in which the charging mode of the aerosol-generating device 10 is the fast charging mode, the image 4810 corresponding to completion of charging of the battery 16 may be displayed in place of the image 4620 corresponding to the fast charging mode. In addition, the image 4810 corresponding to completion of charging of the battery 16 and the image 4620 corresponding to the fast charging mode may be alternately displayed at a predetermined time interval (e.g. 1 second).

As described above, according to at least one of the embodiments of the present disclosure, it may be possible to provide various pieces of information about the state of the aerosol-generating device 10 to the user through the display 610.

In addition, according to at least one of the embodiments of the present disclosure, it may be possible to intuitively display information about an operation that is currently performed by the aerosol-generating device 10.

In addition, according to at least one of the embodiments of the present disclosure, it may be possible to update settings related to the aerosol-generating device 10 in various manners using one button 620.

Referring to FIGS. 1 to 48, an aerosol-generating device 10 in accordance with one aspect of the present disclosure may include a heater 110 configured to heat an aerosol-generating substance, a display 610, a button 620, and a controller 17. Upon receiving first input through the button 620 while a screen indicating a first state among a plurality of states is displayed, the controller 17 may change the screen indicating the first state to a screen indicating a second state among the plurality of states. Upon receiving second input, which is different from the first input, through the button 620 while the screen indicating the first state is displayed, the controller 17 may change the screen indicating the first state to a setting screen related to the first state. Upon receiving input through the button 620 while the setting screen related to the first state is displayed, the controller 17 may update settings related to the first state. The controller 17 may change the setting screen related to the first state to the screen indicating the first state in response to update of the settings related to the first state.

In addition, in accordance with another aspect of the present disclosure, the first input may be input performed by a user pressing the button 620 for less than a predetermined time period, and the second input may be input performed by the user pressing the button 620 for the predetermined time period or longer.

In addition, in accordance with another aspect of the present disclosure, the aerosol-generating device may further include a memory 14 configured to store data on a use pattern. When an amount of data on the use pattern stored in the memory 14 is equal to or greater than a predetermined reference amount, the controller 17 may display a screen indicating completion of collection of the use pattern on the display 610. When a screen indicating a third state corresponding to the use pattern among the plurality of states is initially displayed after the screen indicating completion of collection of the use pattern is displayed, the controller 17 may display an image corresponding to completion of collection of the use pattern on the screen indicating the third state.

In addition, in accordance with another aspect of the present disclosure, the controller 17 may output a screen indicating a fourth state corresponding to normal charging among the plurality of states on the display 610 in response to setting of a mode corresponding to the normal charging. Upon receiving input through the button 620 while the screen indicating the fourth state is displayed, the controller 17 may change the mode corresponding to the normal charging to a mode corresponding to communication.

An operation method of an aerosol-generating device 10 in accordance with one aspect of the present disclosure may include changing, upon receiving first input through a button 620 while a screen indicating a first state among a plurality of states is displayed on a display 610 included in the aerosol-generating device 10, the screen indicating the first state to a screen indicating a second state among the plurality of states, changing, upon receiving second input, which is different from the first input, through the button 620 while the screen indicating the first state is displayed, the screen indicating the first state to a setting screen related to the first state, updating, upon receiving input through the button 620 while the setting screen related to the first state is displayed, settings related to the first state, and changing the setting screen related to the first state to the screen indicating the first state in response to update of the settings related to the first state.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device comprising:
a heater configured to heat an aerosol-generating substance;
a display;
a button; and
a controller configured to:
cause the display to display a screen indicating a first state, from among a plurality of states;
change, in response to receiving a first input at the button while the screen indicates the first state, the screen indicating the first state to a screen indicating a second state, from among the plurality of states;
change, in response to receiving a second input at the button while the screen indicates the first state, the screen indicating the first state to a setting screen related to the first state, wherein the second input is different from the first input;
update, in response to receiving an input at the button while the setting screen related to the first state is displayed, settings related to the first state; and
change the setting screen related to the first state to the screen indicating the first state, in response to the update of the settings related to the first state.

2. The aerosol-generating device according to claim 1, wherein the first input is in response to a user pressing the button for less than a defined time period, and
wherein the second input is in response to the user pressing the button for the defined time period or longer.

3. The aerosol-generating device according to claim 1, further comprising:
a memory configured to store data of a usage pattern,
wherein the controller is further configured to:
cause the display to display a screen indicating completion of collection of the usage pattern, based on an amount of data of the usage pattern stored in the memory being equal to or greater than a defined reference amount; and
cause the display to display an image corresponding to the completion of collection of the usage pattern on a screen indicating a third state, wherein the third state corresponds to the usage pattern among the plurality of states and is initially displayed after the displaying of the screen indicating the completion of collection of the usage pattern.

4. The aerosol-generating device according to claim 1, wherein the controller is further configured to:
cause the display to display a screen indicating a fourth state, in response to setting of a mode corresponding to normal charging, wherein the fourth state corresponds to normal charging and is one of the plurality of states; and
change the mode corresponding to the normal charging to a mode corresponding to communication, in response to receiving an input at the button while the screen indicating the fourth state is displayed.

5. A method for operating an aerosol-generating device having a display, the method comprising:
displaying, on the display, a screen indicating a first state, from among a plurality of states;
changing, in response to receiving a first input while the screen indicates the first state, the screen indicating the first state to a screen indicating a second state, from among the plurality of states;
changing, in response to receiving a second input while the screen indicates the first state, the screen indicating the first state to a setting screen related to the first state, wherein the second input is different from the first input;
updating, in response to receiving an input while the setting screen related to the first state is displayed, settings related to the first state; and
changing the setting screen related to the first state to the screen indicating the first state, in response to the update of the settings related to the first state.

6. The method according to claim 5, further comprising:
displaying, on the display, a screen indicating completion of collection of the usage pattern, based on an amount of data on the usage pattern being equal to or greater than a defined reference amount; and
displaying, on the display, an image corresponding to the completion of collection of the usage pattern on a screen indicating a third state, wherein the third state corresponds to the usage pattern among the plurality of states and is initially displayed after the displaying of the screen indicating the completion of collection of the usage pattern.

7. The method according to claim 5, further comprising:
displaying, on the display, a screen indicating a fourth state, in response to setting of a mode corresponding to normal charging, wherein the fourth state corresponds to normal changing and is one of the plurality of states; and
changing the mode corresponding to the normal charging to a mode corresponding to communication, in response to receiving an input while the screen indicating the fourth state is displayed.

8. An aerosol-generating device comprising:
a heater configured to heat an aerosol-generating substance;
a display;
a button; and
a controller configured to:
cause the display to display a first screen indicating a first state, from among a plurality of states;
cause the display to stop the displaying of the first screen and cause the display to display a second screen indicating a second state, in response to receiving a first input at the button while the first screen is displayed, wherein the second state is one of the plurality of states;
cause the display to stop the displaying of the first the screen and cause the display to display a setting screen related to the first state, in response to receiving a second input at the button while the first screen is displayed, wherein the second input is different from the first input;
update settings related to the first state, in response to receiving an input at the button while the setting screen is displayed; and
cause the display to display the first screen according to the updated settings.

9. The aerosol-generating device according to claim 8, further comprising:
a memory configured to store data of a usage pattern,
wherein the controller is further configured to:
cause the display to display a screen indicating completion of collection of the usage pattern, based on an amount of data of the usage pattern stored in the memory being equal to or greater than a threshold amount; and
cause the display to display an image corresponding to the completion of collection of the usage pattern on the third screen indicating a third state, wherein the third state corresponds to the usage pattern among the plurality of states and is initially displayed after the displaying of the screen indicating the completion of collection of the usage pattern.

10. The aerosol-generating device according to claim 8, wherein the controller is further configured to:
cause the display to display a fourth screen indicating a fourth state, in response to setting of a mode corresponding to normal charging, wherein the fourth state corresponds to normal changing and is one of the plurality of states; and
change the mode corresponding to the normal charging to a mode corresponding to communication, in response to receiving an input at the button while the fourth screen is displayed.
